(19) United States
(12) Patent Application Publication
(10) Pub. No.: US 2003/0120574 A1
(43) Pub. Date: Jun. 26, 2003

(54) Method and apparatus for creating investment advice marketplace

(75) Inventor: Steven M. H. Wallman, Great Falls, VA (US)

Correspondence Address: MAYER, FORTKORT & WILLIAMS, PC, 251 NORTH AVENUE WEST, 2ND FLOOR, WESTFIELD, NJ, 07090, US

(73) Assignee: FOLIOfn, Inc.

(21) Appl. No.: 10/298,185

(22) Filed: Nov. 15, 2002

Related U.S. Application Data
(60) Provisional application No. 60/332,348, filed on Nov. 15, 2001.

(51) Int. Cl. G06F 17/60

(52) U.S. Cl. 705/36

(57) ABSTRACT

A method for creating an electronic marketplace of investment advice for consumers, each of which are engaged in electronic portfolio trading of market tradable assets/liabilities enables advisors to each create a model portfolio of market tradable assets/liabilities and then disseminate the model portfolios to potential consumers. These model portfolios created by the advisors are disseminated as preset portfolios that can be purchased singly or in combination with each other by one or more consumers, a result of which can then be electronically traded as an entire portfolio of market tradable assets/liabilities by the one or more consumers. Along with each model portfolios a fee associated with each of the model portfolios is displayed. This fee is that which must be paid to the advisor that created the model portfolio upon selecting to purchase the model portfolio singly or in combination with one or more other model portfolios. Any fee associated with a particular model portfolio purchased by a consumer is deducted from funds allocated to the purchased portfolio and then forwarded to the respective advisor. The above method uses a computer-based portfolio manager system that enables a user to create and manage a portfolio of investments.

### RELATED APPLICATIONS

This application claims the benefit of priority to U.S. Provisional Patent Application No. 60/332,348 entitled “Method and Apparatus for Creating Investment Advice Marketplace”, filed Nov. 15, 2001.

The present invention is related to U.S. patent application Ser. No. ______ [Attorney docket number 10392-47301] entitled “Method and Apparatus for Providing Investment Advice to Multiple Investors,” filed on Nov. 15, 2002. The present invention is also related to U.S. patent application Ser. No. 09/038,158, entitled “Method and Apparatus for Enabling Smaller Investors or Others to Create and Manage a Portfolio of Securities or Other Assets or Liabilities on a Cost Effective Basis”, filed on Mar. 11, 1998. The present invention is also related to U.S. patent application Ser. No. 09/139,020, entitled “Method and Apparatus for Enabling Smaller Investors or Others to Create and Manage a Portfolio of Securities or Other Assets or Liabilities on a Cost Effective Basis”, filed on Aug. 24, 1998. The present invention is also related to U.S. patent application Ser. No. 09/339,299, entitled “Method and System for Investing in a Group of Securities that are Selected Based on the Aggregated, Individual Preferences of Plural Investors”, filed on Jun. 24, 1999. Each of these applications was filed by the inventor of the present invention. U.S. patent application Ser. Nos. ______ [Attorney Docket No. 10392-47301], 09/038,158, 09/139,020, and 09/339,299 are each hereby incorporated by reference as if repeated herein in their entirety, including the drawings.

### BACKGROUND OF THE INVENTION

The present invention relates generally to methods and systems for facilitating investments. More specifically, the present invention relates to a method and system for facilitating investments over a computer network using a computer-based system for creating, managing, and trading user specifiable portfolios of investments.

The above-mentioned related applications disclose, inter alia, embodiments of systems, methods, and apparatuses for enabling investors, both large and small, to create, manage, and trade portfolios of investments. In certain embodiments, each investor is provided the ability to select and purchase various investment vehicles as part of their portfolio. Among other things, investors are provided the ability to select portfolios of securities based on their risk/reward characteristics relative to the market, their desire to invest in particular types of investments, and other criteria. This provides an easy way for even relatively novice investors to select diversified portfolios of securities or other investments.

Although many investors might be comfortable selecting from among the large number of securities currently available for trading, others might feel overwhelmed by so many choices. These investors might prefer assistance when selecting securities for investments. Without such assistance, these investors might not choose to invest in portfolios of directly owned investments, and instead might remain invested in mutual funds because of the professional management such funds provide, despite the many disadvantages associated with these funds vis-à-vis directly owned securities investments, as set forth in detail in the above-mentioned related patent applications.

Some types of automated investment advisers exist, such as Financial Engines, Direct Advice, Clear Future, etc. These advisers generally direct investors to mutual funds or individual stocks in a non-diversified portfolio, rather than to portfolios of directly owned investments. Consequently, these are merely front ends to selecting mutual funds or individual stocks in a non-diversified portfolio, hence they inherently have the same disadvantages that mutual funds have or investing in a non-diversified portfolio. Moreover, these automated investment advisers do not enable one to create, manage, and trade a portfolio of directly owned investments.

Even “automated” advisors that take investors through screens to develop a “personalized” portfolio of securities do not provide a means to manage and trade the portfolio, and do not provide the customization from professional money managers managing the portfolio.

Alternatively, an investor can employ a professional investment manager to provide investment advice. However, the costs associated with such professional investment advice usually preclude smaller investors from seeking it. Moreover, professional investment advisers cannot provide their advice on a cost-effective basis due to the limitations associated with providing this advice on an individual-by-individual basis. Furthermore, the relatively small profits usually achieved by smaller investors generally do not cost-justify the expense of professional input. Thus, neither the provider of, nor the consumer of this advice is motivated to modify their behavior to encourage these transactions, i.e., providing investors with investment selection advice for individually owned portfolios of securities. As a result, purveyors of professional investment advice normally provide their advice to smaller investors via specific investment vehicles, such as mutual funds, or through general information such as newsletters or analysts recommendations. Yet, the above-mentioned patent applications set forth significant disadvantages of investing in mutual funds or non-diversified investments. Therefore, many investors are essentially in a quandary, either they can invest in mutual funds and accept the significant disadvantages, or can pay the costs associated with the professional investment advice, thereby reducing the ultimate return on his investments over time due to these costs. Of course, investors can forego any professional advice, which might have other deleterious affects on the return on their investment. None of these alternatives is particularly appealing.

Moreover, the provision of investment advice is currently not amenable to fierce competition in that comparing the quality and cost of investment advice is time consuming and difficult.

The present invention is therefore directed to the problem of facilitating investors' personalized portfolio investments in a cost-effective manner.

### SUMMARY OF THE INVENTION

The present invention solves these and other problems by inter alia creating a virtual marketplace for investment advice in which providers of investment advice and consumers of investment advice can meet and interact in a manner that facilitates competition and the concomitant benefits of this competition. By forcing investment advisors to provide investment advice in the form of model investment portfolios, the present invention enables investment advice to be presented as a commodity that can then be compared both in cost and performance against each other. Moreover the purchasing decisions made by the investors provides the necessary feedback to the generators of the model portfolios and their associated prices.

According to an exemplary embodiment of the present invention, a method for creating an electronic marketplace of investment advice for consumers of investment advice, each of which are engaged in electronic portfolio trading of market tradable assets/liabilities includes enabling multiple advisors to each electronically create a model portfolio of market tradable assets/liabilities and then electronically disseminating the model portfolios created by the advisors as preset portfolios that can be purchased singly or in combination with each other by one or more consumers, a result of which can then be electronically traded as an entire portfolio of market tradable assets/liabilities by the one or more consumers. According to this exemplary embodiment, the method includes displaying a fee associated with each of the model portfolios that must be paid to an advisor that created the model portfolio upon selecting to purchase each of the model portfolios singly or in combination with one or more other model portfolios. This provides the competitive marketplace by which consumers can make purchasing decisions, which creates the incentives for price and quality competition.

Exemplary embodiments of the present invention provide an integrated computer interface and communications link to an investment adviser as part of a computer-based portfolio investment manager system, so that a user can obtain a professional investment adviser's recommendations in the form of preset model portfolios of market tradable assets/liabilities, yet still invest in directly owned investments without the usual concomitant cost accompanying such recommendations.

An exemplary embodiment of an apparatus for providing this capability in a computer-based system includes a computer interface and communications link via which one or more investment advisers can provide to users complete model portfolios of market tradable assets/liabilities, which can then be tailored by an investor in accordance with his or her own particular desires. This enables investors to select preset portfolios as their investment portfolio, if desired. By spreading the cost of recommending these portfolios across a large number of potential users, the cost to obtain this advice is minimal. Moreover, by enabling a third party investment adviser to provide advice via computer and without requiring human interaction with the recipient, this embodiment makes it possible for the investment adviser to provide investment recommendations on a continual basis to many investors while making a quite reasonable profit. Thus, a single investment adviser can serve many investors, without any particular limit on the number of investors.

### BRIEF DESCRIPTION OF THE DRAWINGS

FIG. 1 depicts an exemplary embodiment of a portfolio manager according to one aspect of the present invention.

FIG. 2 depicts an exemplary embodiment of a method according to another aspect of the present invention for modifying a recommended folio.

FIG. 3 depicts an exemplary embodiment of another method according to yet another aspect of the present invention for rebalancing to a revised recommended folio while incorporating previous user modifications.

FIGS. 4-24 and 27-52 depict various screens used in interacting with the user by the various embodiments of the present invention.

FIGS. 25 and 26 depict the process flow of two exemplary embodiments of the present invention.

### DETAILED DESCRIPTION

Any reference herein to “one embodiment” or “an embodiment” means that a particular feature, structure, or characteristic described in connection with the embodiment is included in at least one embodiment of the invention. The appearances of the phrase “in one embodiment” in various places herein are not necessarily all referring to the same embodiment.

As used herein, the phrase “asset/right/liability” refers to any market tradable commodity or item of value in which there exists a market, however small, for trading. This includes both instruments and non-instruments. Examples of instruments include: securities, equities, bonds, futures, mutual funds, derivatives, currencies (both national and foreign), commodities, insurance contracts, mortgages, investment contracts, hedge funds, high-yield debt, foreign debt, convertible debt, notes, pollution rights, development rights, leases, loans, real estate investment trusts, etc. Examples of non-instruments include without limitation: airline reservations, hotel reservations, time share rights, golf tee times, country club memberships, antiques, telecommunications bandwidth, factory capacity, real estate, consumer coupons, airline miles, hotel miles, consumer reward program credits, etc. Although the computer-based system of the present invention can be used for any asset, right, and/or liability that is traded, for brevity the discussion herein relates primarily to its use in connection with tradable instruments or securities, and particularly to stocks. The phrase “assets/rights/liabilities” refers to any collection of assets/rights/liabilities.

As used herein, the phrase “manager” refers to any person other than the user who manages the portfolios in which the user invests. A manager can be professional, as in the case of a professional asset manager employed by an asset management firm or by the system proprietor, or can be an amateur, as in the case of a manager who does not receive compensation. A manager can manage the portfolios to maximize their investment return, or to obtain other objectives, such as providing a portfolio of securities issued by companies that the manager believes further social goals (for example, an environmental organization could manage a portfolio of securities issued by companies that are environmentally friendly). A manager can be active, as in the case of a manager who participates directly in the creation and periodic or continual revision of portfolios, or passive, as in the case of a manager who simply provides and periodically or continually revises a list of investments to the public which list is then converted into a portfolio of investments by the system proprietor without any direct participation by the manager.

Embodiments of the present invention include a computer interface and communications links to multiple investment advisers integrated with a computer-based portfolio investment management system via which an investor can select and purchase a professional investment adviser's investment recommendations that have been packaged in commodity form as a model investment portfolio from among multiple competing investment advisors providing competing model investment portfolios. Moreover, the embodiments enable investors to continue to invest in directly owned investments without the usual concomitant cost accompanying such investing and associated investment advice. The end result is that smaller investors can for the first time conduct diversified investing with advice from highly capable investment advisors, which has only been previously available to institutional and wealthy investors.

An exemplary embodiment of an apparatus for providing this capability in a computer-based system includes a computer interface and communications link via which one or more investment advisers can provide to users complete portfolio recommendations of market tradable assets/liabilities, which can then be tailored by an investor in accordance with his or her own particular desires. This enables investors to select preset portfolios as their investment portfolio, if desired. By spreading the cost of recommending these portfolios across a large number of potential users, the cost to obtain this advice is minimal to each investor. Moreover, by enabling a third party investment adviser to provide advice via computer and without requiring human interaction with the recipient, this embodiment makes it possible for the investment adviser to provide investment recommendations on a continual basis to many investors while making a quite reasonable profit. Thus, a single investment adviser can serve many investors, without any particular limit on the number of investors that would otherwise exist if the investment advisor were personally interacting with each investor.

Additional embodiments enable the investment advisor to provide dynamic investment advice to approved subscribing investors by enabling the advisors to update their investment advice and to automatically rebalance investment portfolios of the approved subscribing investors, if desired by the investors. For those investors that customize these model portfolios, various embodiments enable the investor to store the customization modifications and to automatically implement these customization modifications in the rebalanced model portfolio, if desired. An example of this includes deselecting certain investments (e.g., tobacco stocks) and replacing them with other investments (e.g., another stock or stocks), thereby enabling the system to automatically replace these investments in future updated model portfolios.

Embodiments of the present invention provide an integrated computer interface and communications link to an investment adviser as part of a computer-based portfolio investment manager system, so that a user can obtain a professional investment adviser's recommendations and yet have the user's portfolio personalized for the user while still investing in directly owned investments without the usual concomitant cost accompanying such recommendations.

An exemplary embodiment of an apparatus for providing this capability in a computer-based system includes a computer interface and communications link via which one or more investment advisers can provide to users complete portfolio recommendations of market tradable assets/liabilities, which can then be tailored by an investor in accordance with his or her own particular desires. This enables investors to select preset customizable portfolios as their investment portfolio, if desired. By spreading the cost of recommending these portfolios across a large number of potential users, the cost to obtain this advice is minimal. Moreover, by enabling a third party investment adviser to provide advice via computer and without requiring direct human interaction with the recipient, this embodiment makes it possible for the investment adviser to provide investment recommendations on a continual basis to many investors while making a quite reasonable profit. Thus, a single investment adviser can serve hundreds or even thousands or tens of thousands of investors, without any particular limit on the number of investors.

The computer-based portfolio system, to which the present invention is applicable, is described in detail in the patent applications mentioned in the related application section herein. Each of these patents is hereby incorporated by reference as if repeated herein in its entirety, including the drawings.

System Overview

The computer-based portfolio manager system enables investors to create, manage, and trade a diversified portfolio of investments, which can be created from among the thousands of publicly traded securities. By selecting a portfolio of individual investments rather than single investments, an investor can take advantage of the modern portfolio theory that suggests one can obtain a better risk-adjusted return in the long run on average by investing in a broader range of investments rather than in a few select investments. The present invention provides this capability to even small investors by enabling them to spread an investment across many assets/rights/liabilities in a cost-effective manner that would otherwise make such diverse investing impractical.

User Interface to Select Investments

As each user can own multiple sub-portfolios (i.e., a grouping of assets/rights/liabilities) in his or her portfolio of investments, the term “folio” will be used to refer to a sub-portfolio that can comprise one's portfolio. Using the present invention, a user can select a “folio” of investments from several available. The user is then able to directly invest an amount of money in this folio. Each folio can be comprised of assets/rights/liabilities, but as mentioned above, for brevity the discussion herein will mainly refer to instruments or securities, such as stocks.

To aid a user in selecting investments from the large number of publicly traded instruments, the present invention provides a user interface that helps a user provide inputs to the system, which inputs are then used to select the instruments for the user's portfolio.

In some embodiment, among other things, investors are provided the ability to select portfolios of securities based on their risk/reward characteristics relative to the market, their desire to invest in particular types of investments, and other criteria. These criteria are then used to select instruments that match the user's investment goals using standard techniques of risk/reward analysis and investment recommendations.

Portfolio Design

As discussed in the background section, some users prefer to invest in portfolios selected and/or maintained by others, including professional investment advisers and/or asset managers. These portfolios can include three aspects that some investors prefer. First, these portfolios can include investments selected by professionals having experience in picking investments. Second, these recommended portfolios might include sell recommendations based on a prediction and/or belief that these identified investments have reached an apex (at least for some period and will therefore be a relatively poor performer for some time). Thus, many investors prefer someone to tell them when it is appropriate to sell their investment. Not all investors will follow both the buy and sell recommendations, for reasons set forth below. However, these buy and sell recommendations can be valuable advice to many investors, without which some investors might be reluctant to invest in directly owned investments. Third, and perhaps most importantly, the portfolios can be constructed professionally by a person with skill in creating whole portfolios. Under modern portfolio theory, the risk-return of a portfolio is different from the risk-return of the individual stocks in the portfolio, and consequently, to obtain an appropriate portfolio, it is important to have one constructed well; that may require a professional.

Thus, embodiments of the present invention provide an interface to the computer-based portfolio management system, via which interface can provide input, in the form of investment buy and sell recommendations, as well as complete folios, which users can select for investing.

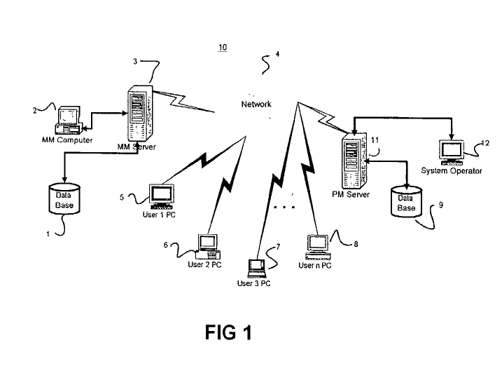

FIG. 1 shows an exemplary embodiment of a system 10 for implementing a manager's input to the computer-based portfolio management system. System 10 includes a computer 2 used by the manager to input the manager's folio to the portfolio management system operating on portfolio manager server 11 via. ??? Alternatively, the folio could be input like any other user's folio, with a few modifications to account for the fact that the manager is not investing. The manager's folio could be a “watch or tracking folio” created by the manager that the system then transmits to all users 5-8 as one of the preset folios. (A watch or tracking folio is a folio that one can use to track potential investments without actually investing any money. In a watch or tracking folio, a user can select an amount he or she might wish to invest and then watch the investment grow (or not) as if he or she was actually invested.) The manager's folio is stored in the system database 9 and also by the manager in his database 1. A system operator 12 controls the access and performance of the portfolio manager 11.

System 10 includes a communications link via the Internet 4, for example, over which a manager can provide a complete folio. The communication path to the Internet can include a server 3 and/or an Internet connection via for example, a telephone modem, a cable modem, a cellular modem, and/or a satellite link, etc.

One embodiment of the portfolio manager system includes folios of: Internet stocks, biotechnology stocks, stocks with high betas, stocks with low betas, etc. Via the manager's interface, a manager can provide a complete recommended folio or folios (termed herein as the “manager's folio”) tailored to the securities available to the system. Users can then select one or more manager's folios just like any other preset folios.

A manager's folio can include multiple securities, e.g., between approximately two to ten securities, five to forty securities, and/or thirty to fifty securities, and a relative percentage of the total investment assigned to each security. For example, the portfolio could consist of fifty securities, each of which is assigned a relative percentage of 2%. Thus, for every $100 invested in this folio, $2 would be invested in each security. The same manager could recommend multiple folios, among which a user could select. Alternatively, multiple managers could provide recommended folios, among which a user could select. Thus, a user could select multiple folios each managed by a different manager.

Non-equal percentages are also possible. An example of this would be to assign a percentage to each security based on its relative market capitalization. In this instance, the market capitalization of each security would be added to form a total market capitalization for these securities. The individual ratios would be calculated by dividing each individual security's market capitalization by the total market capitalization for these securities. For example, if the total market capitalization of all securities in the folio were $100,000,000 and a particular security had a market capitalization of $10,000,000, then the assigned ratio would be 10,000,000/$100,000,000=0.10 (or 10%).

The securities could also be weighted based on the manager's belief in the relative strength of the various securities.

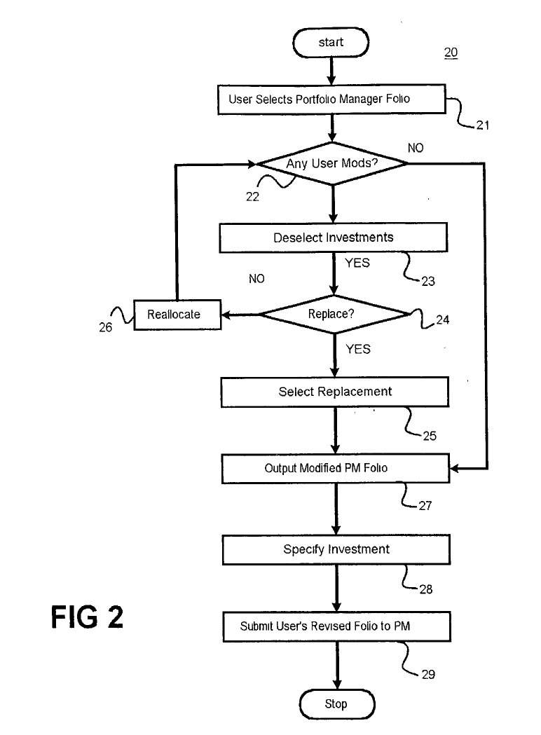

FIG. 2 shows an exemplary embodiment of a process and/or method 20 for modifying a manager's portfolio by a user. At activity 21 the user selects the manager's folio. At activity 22 the user is offered the opportunity to perform any modifications to the manager's folio. Such modifications could be composition modifications measured by, for example, the percentages, ratios, or dollar values of any stock in the folio. Such modifications could also include selection modifications, wherein certain stocks presented in the manager's folio are deselected. If the user does not wish to perform any modifications, the process proceeds to activity 27 and outputs the unmodified folio. If the user does wish to make modifications, at activity 23 the user is permitted to make those modifications.

At activity 24 the user is then provided the option of replacing any stock that is deselected. If the user wishes to replace the deselected stock, at activity 25 the user selects the replacement. If the user does not wish to replace the deselected stock, at activity 26 the user can reallocate the amount of the deselected stock across the remaining stocks. This returns the user to the user modification activity 22. If there are no remaining modifications, the process proceeds to activity 27 and outputs the modified folio to storage. The user's modifications are stored to enable future modifications to any changes that might occur in the manager's folio.

Once the modified folio is created, at activity 28 the user can select the amount of any investment for the entire folio. At activity 29, the folio and the investment amount is then submitted to the portfolio manager system for execution, and the process ends.

As the securities in the manager's folio change based on changes by the manager, the system notifies its users that a revised version of the manager's folio is now available. This notification can occur each time the manager's folio changes, or at other intervals, such as daily, weekly, monthly, and/or quarterly. These changes can occur on a periodic basis, such as quarterly, monthly, weekly, daily, and/or perhaps even hourly, or on a non-periodic basis, and in certain embodiments, always under the control of the manager. A user can then rebalance his investments in accordance with the revised folio in the same manner the user would otherwise rebalance his folio to account for changes in stock valuations, market capitalization, etc.

For example, if a user's folio varied from a manager's revised folio as a result of a change in investment allocation by the manager, the user could rebalance by buying, selling, or both, as discussed below.

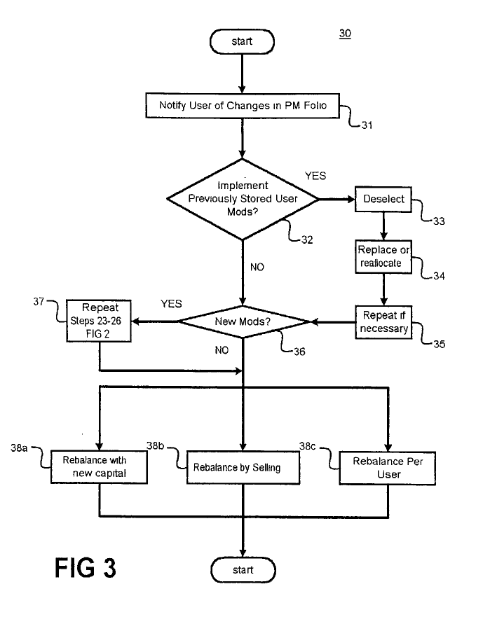

FIG. 3 shows an exemplary embodiment of a process and/or method 30 for implementing changes to a manager's folio received from the manager. This example assumes that the manager's folio includes only stocks, however, as discussed above, any folio can contain any assets, rights or liabilities. At activity 31, upon receipt of any changes in the manager's folio, the system notifies all subscribers to the manager's folio. At activity 32, before making any changes, the system queries the user as to whether the user wishes to implement his or her previous modifications to the manager's folio. If so, at activities 33-35, the user's previously stored changes are made to the newly received folio.

At activity 36, the user is also asked whether the user wishes to make any new changes. If so, in activity 37 the system repeats activities 23-26 from FIG. 2. If there are no new changes, the process proceeds to rebalancing the user's existing portfolio to the manager's newly received (or newly modified) folio. This rebalancing can be performed, as discussed above, at activity 38a by rebalancing with new capital, or at activity 38b by rebalancing by selling, or at activity 38c by rebalancing in a manner selected by the user. The new ratios set in the manager's newly received (or newly modified) folio are compared to the current market values and the differences determine how much rebalancing is required. If there are some stocks missing in the manager's newly received (or newly modified) folio that are currently in the user's version of this folio, these stocks are sold (or moved to the holding folio). If some stocks are in the manager's newly received (or newly modified) folio but are not currently in the user's version of this folio, these stocks are purchased. Before purchasing any stocks, the system will look first to the user's holding folio, if any, and use those shares of the missing stocks in the holding folio before purchasing any new shares of these stocks.

The communications link to the manager can include an application program interface (API) to the portfolio manager system. This communications link can also include an Internet Protocol communications session between a computer (e.g., a server) disposed in the manager's system and a computer (e.g., a server) disposed in the portfolio manager system. These servers can communicate using, for example, HyperText Transfer Protocol (HTTP) or secure HTTP (HTTPS). The information can be transferred using a predetermined protocol, such as the Financial Information Exchange (FIX) protocol, eXtensible Markup Language (XML), etc.

During this session, the manager can create a portfolio of investments in the same manner as a user, except that the manager's folio does not necessarily include an amount to be invested. The manager can recommend that users invest more of their annual investment at certain times of the year and less at other times of the year based on market valuations, and/or other factors such as expected changes in interest rates, expected earnings announcements, and/or the manager's analysis of the outlook for the market. The manager's folio can suggest specific amounts to invest or percentages of annual investments to be spread across one's folio. These recommendations can be in the form of weighted buy/sell recommendations.

In addition, a user might prefer to not own certain stocks in the manager's folio. These stocks can be deselected from the user's version of the manager's folio when the user creates his or her folio. For example, when initially creating the folio, the user can specify certain stocks or securities, such as tobacco stocks, military stocks, etc., which are to be permanent removed from the user's version of this folio.

Thus, for example, when the user clicks on the manager's folio indicating that the user wishes to select that folio as an investment vehicle, the user then can be asked whether the user wants to modify this folio. If not, the process can proceed with asking the user how much the user wants to invest. If the user answers “YES” indicating the user wants to modify the folio, the user then can be allowed to deselect certain securities, select additional securities to be included, and/or revise the proportions. Each of these modifications can be stored in a “delta file” so that when the user later rebalances his folio to the manager's subsequently revised folio, the revised folio can be adjusted in accordance with the user's modifications. The system can store the modifications in the “delta file” and then, after rebalancing one's folio in accordance with the manager's folio revisions, implements the user's “standard” modifications.

As another example, if a user deselected tobacco stocks and put the money that would otherwise be invested in the tobacco stocks in pharmaceutical stocks (substituted for the tobacco stocks) the future revisions to the user's folio could be treated similarly. The amount of money otherwise invested in the tobacco stocks could be invested in the stock or stocks as specified by the user, or spread across the other stocks within the folio in equal proportions or some other proportion specified by the user, such as for example, market capitalization ratios.

In an exemplary alternative embodiment, the manager can be provided a web page on the system that requires a password and user ID, which can be known only to the manager. To create and modify the manager's folio, the manager can merely log-on to the system and create a portfolio just like any other user. This can guarantee that the manager is using the same stocks available to the users of the system. Moreover, the manager can then provide investment recommendations that are timed to the system daily trades.

In another exemplary embodiment, multiple managers can each provide one or more recommended folios among which users can select as portfolios. Thus, a user could own multiple folios in a single account each of which is managed by a different manager. Moreover, users can select multiple folios to create a single folio that inherently includes the advice from multiple managers.

For example, a first manager could recommend 20 securities, each having assigned weights. A second manager could recommend 25 securities, each having assigned weights, which 25 securities might have some overlap with the 20 securities recommended by the first manager. A third manager could recommend 30 securities, each having assigned weights. A user could then select these three recommended folios, in equal percentages, from among a large number of recommended folios to aggregate into a single user's folio. The individual weights would be the sum of the weights assigned by the manager divided by the number of aggregated folios (i.e., three in the example). So, if folio 1 included security A having a weight of 5%, folio 2 included security A having a weight of 4% and folio 3 included security A having a weight of 3%, the aggregated weight of security A in the user's aggregated folio would be 4%.

Alternatively, the user could apply a weight to average the three folios. In this case, the aggregated weight would be the weighted average of the weights in the three folios. For those folios not including a particular security, its contribution to the weighted sum would be zero.

Alternatively, the user could re-weight the individual assets/rights/liabilities in any manner desired. In this case, the user would simply be aggregating the total securities being recommended and then apply his or her own weights to the total securities.

Investment Advisor Marketplace

The embodiments of the invention also include an investment advisor marketplace, which enables users of the portfolio manager system to obtain investment advice from multiple investment advisors. These investment advisors compete with each other for the users' selection, thereby at least potentially improving the quality and price of the investment advice. Thus, the present invention provides for the first time a mechanism for creating a virtual marketplace of investment advice that directly competes for customers. As such, this aspect of the present invention enables the attributes and benefits of competition to play out in the selection of investment advice. These benefits include increased performance, lower cost and better service.

According to this aspect of the present invention, each investment advisor provides one or more recommended portfolios as described above. These portfolios (or folios) are presented to the user along with other preset folios. The users can select one or more of the investment advisor folios from among which to create their own folios. For example, a user can aggregate two or more folios from various investment advisors to create a single folio. To do so, the user simply applies a weight to the selected folios and the system then creates one large folio with the appropriate mix of investments, as if the separate folios were individual securities.

In addition, the investment advisors can vie for the users' business by offering different pricing models for their folios. For example, some investment advisors may offer folios for fixed prices. Others may offer folios for free initially, but if the investments prove profitable, receive back a portion of the return. In the latter case, the investment advice is only paid for if profitable above a predetermined value set by the investment advisor. For example, an investment advisor may offer his folio for a 1% return if the investment returns over 10% over predetermined period. Multiple pricing strategies are possible. For example, an investment advisor may offer her folio for a 1% return if the investment returns over 10%, 2% if the investment returns over 20% and 5% if the investment returns over 30% over a predetermined period. These pricing schemes become possible as the investments are controlled by the portfolio manager system. Moreover, the tracking of these investments is handled for the investment advisor, thereby making it possible to price their advice in this manner.

Alternatively, a folio may be recommended in case of a bear market, e.g., the investment advisor recommends a folio that will outpace inflation over a predetermined period, and if so, the user pays a portion of the return, e.g., 0.1%. Similarly, the folio may be designed to outpace certain indices, the guarantee of which is backed by no fee for folios that fail to meet their design goals.

By placing investment advisors in the position of competing for the users' investments, better investment advice will be offered at the most competitive prices possible. Moreover, by enabling investment advisors to share in returns of users, investment advisors can reap large rewards for profitable advice, thereby creating proper incentives for highly capable investment advisors to offer their advice to users of the system.

Moreover, by providing the possibility for one investment advisor to provide recommendations to potentially millions of users, this embodiment enables investment advisors to reap large profits, thereby furthering the possibility of obtaining the most capable investment advisors available. Currently, these highly capable investment advisors provide advice to large funds, some of which smaller investors cannot become invested in due to investment restrictions. This embodiment removes this impediment by pooling advice to many investors at once without the restrictions applied to hedge funds or other similar investment vehicles.

Each investment advisor is provided a user identification and password, which enables the investment advisor to log into the system at the website and access a graphical user interface that enables the investment advisor to create or modify a folio. Once the folio is created, the investment advisor can make the folio available to the users and specify the fee arrangement, e.g., direct charge or percentage of return over preset returns.

When a user then selects one of these folios, the system requires the user to acknowledge the fee, which is then deducted from the user's account and is transferred to the investment advisor's account, if the fee is a direct charge. If the fee is based on returns, then the user cannot modify the folio and the changes are under control of the investment advisor so that when the investment advisor modifies his folio, these changes are automatically implemented in the user's version as well. Moreover, under this arrangement, the user may not be permitted to withdraw funds from the account during the period for which the fee arrangement is specified, thereby ensuring funds will be available to pay the fee. However, the user may be able to remove the funds related to the folio depending upon the fee arrangement, such as whether it precludes this or requires a penalty for early withdrawal. The fee arrangements based on returns may require minimum balances to prevent users from investing a small amount to obtain the investment advice and then later investing in a self-created account to obtain the benefit of the advice without paying for it.

Alternatively, some accounts may not list the investments selected by the investment advisor, but may merely be blind investments to protect the investment advice. Such accounts may be preferable for some users that cannot know what they are invested in due to their current employment responsibilities, such as a high government official.

When the user's folio obtains the specified returns in the fee arrangement, the system automatically deducts the specified fee or percentage from the user's account and transfers this to the investment advisor. As the system manages the accounts for the user, the system can determine the rates of returns for each investment folio selected by the user that includes a fee arrangement involving returns on the investments in the folio.

If multiple folios are selected, then the fees are paid to the multiple investment advisors.

By acting as the intermediary between investors and investment advisors, the portfolio manager system provides the ability to guarantee payment by users and rendering of service by investment advisors, thereby removing the risk from these parties in dealing with each other.

Moreover, by creating a competitive marketplace for investment advice, the portfolio manager ensures a system that will become profitable for both users and investment advisors.

By providing a commoditized investment vehicle via which investment advisors can provide investment advice, these investment vehicles can then be placed into price and performance competition, thereby creating a competitive marketplace for investment advice that will be profitable for both users and investment advisors. One example of a commoditized investment vehicle is a model portfolio, which can be updated based on market conditions and which updates can be automatically forwarded to purchasers of the model portfolio.

An exemplary embodiment of a method for creating an electronic marketplace of investment advice for consumers of investment advice, each of which are engaged in electronic portfolio trading of market tradable assets/liabilities enables advisors to each electronically create a model portfolio of market tradable assets/liabilities. A server electronically disseminates the model portfolios created by the advisors as preset folios that can be purchased singly or in combination with each other by one or more consumers. The resulting portfolio can then be electronically traded as an entire portfolio of market tradable assets/liabilities by the one or more consumers. A fee associated with each of the model portfolios is displayed along with the model portfolio, which fee must be paid to an advisor that created the model portfolio upon selecting to purchase the model portfolio singly or in combination with one or more other model portfolios. Any fee associated with a portfolio that is purchased by a consumer is automatically deducted from funds allocated to the purchased portfolio and forwarded to the respective advisor.

User Interface and Interaction with Portfolio Manager

Thus, a money manager can create a preset folio that a user can elect to invest in. The user's individual portfolio is then synchronized with the money manager' recommended folio.

Before synchronizing one's individual portfolio to an investment advisor's recommended folio, the model managers and account managers must be defined in the portfolio manager system. Since members can play either or both roles, certain features of the portfolio manager system are conditional to the member. This can be accomplished by creating a set of role flags within the portfolio manager database

Setting up a Model Account

During the membership creation, advisors may indicate whether or not they will be managing models (e.g., by selecting “yes” or “no” radio buttons). If the advisor does not select the option to manage models, he or she may opt to do so at any time by selecting the “Account Settings” tab and modifying their selection. By choosing “yes,” the system will create a model account (and tab) for the advisor.

Conversely, all those who operate solely as model managers are set up through program sponsors. These sponsors can sign up their firms over the phone or in person, or on-line. A membership creation path may be provided for money managers, in addition to CSR screens that will enable the sales staff to create memberships for money managers.

Creating Model Folios

The first step in the process is to create a model FOLIO, which serves as a template for subscribers. The investment club manager, money manager, or other type of model manager will set up a watch FOLIO to represent their model, to which, certain other users will be able to subscribe. If the model manager is also an advisor, he/she will also have his/her own set of actual watch FOLIOs, which may be used to test investment strategies. The model account will be broken down into ‘published’ and ‘unpublished’ models. Published models are those that are currently available for subscription. A model manager can publish his model at any time, however, he/she can only unpublish (and delete) a model if it does NOT have any subscribers.

These new model FOLIOs are created as watch accounts. Model management screens enable the creation and adjustment of these “shareable” watch FOLIOs. Using watch FOLIOs to function as the models enables model managers to track changes (i.e., price fluctuations, corporate actions, etc. . . . ) to their model as they occur.

To describe the functionality of the system and the interaction with the user, several examples will be employed

### EXAMPLE 1

### The Model Manager Creates a Model FOLIO

Assume a model manager has just started using the FOLIO Advisor system. The model manager wishes to create a model FOLIO, to which clients of his/her firm can subscribe. This will be his/her first model FOLIO. This first model will be an Aggressive Growth model comprised of 25 stocks, most of which are from the technology sector.

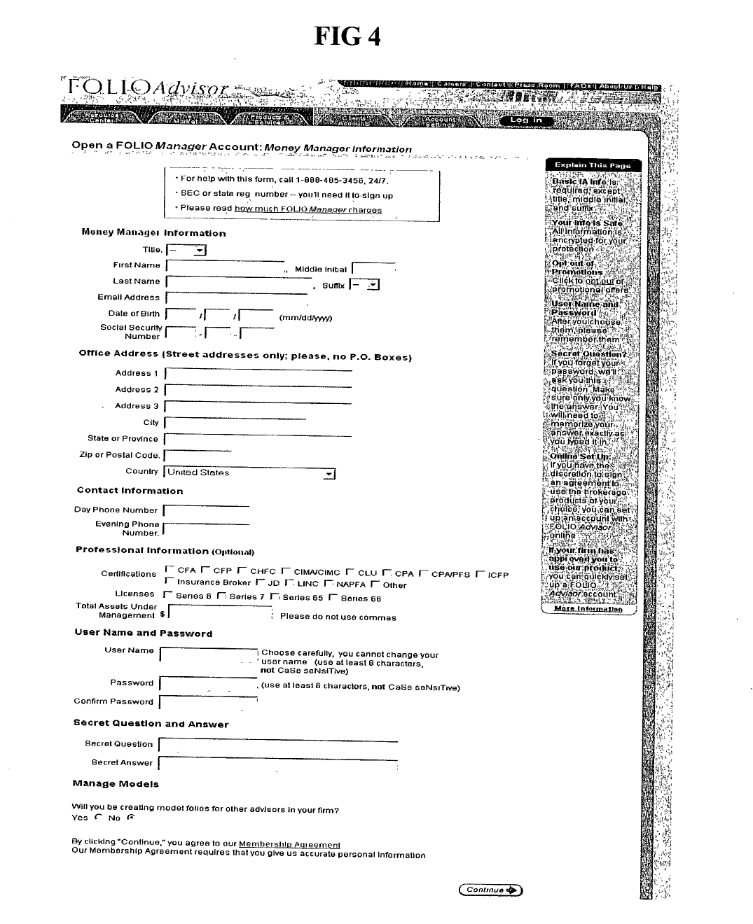

In general, the model manager logs into the Advisor site. He sets up a model FOLIO based on his requirements, names it, enters a fictitious dollar value to invest, and provides subscribers with a brief description. In the process below, the user referred to is a Model Manager. FIG. 4 shows the money manager information page 40. We shall assume in this example that the model manager holds an account with FOLIO Advisor in which he or she is set up as a model manager. The following describes the user interaction with the system in detail for this example.

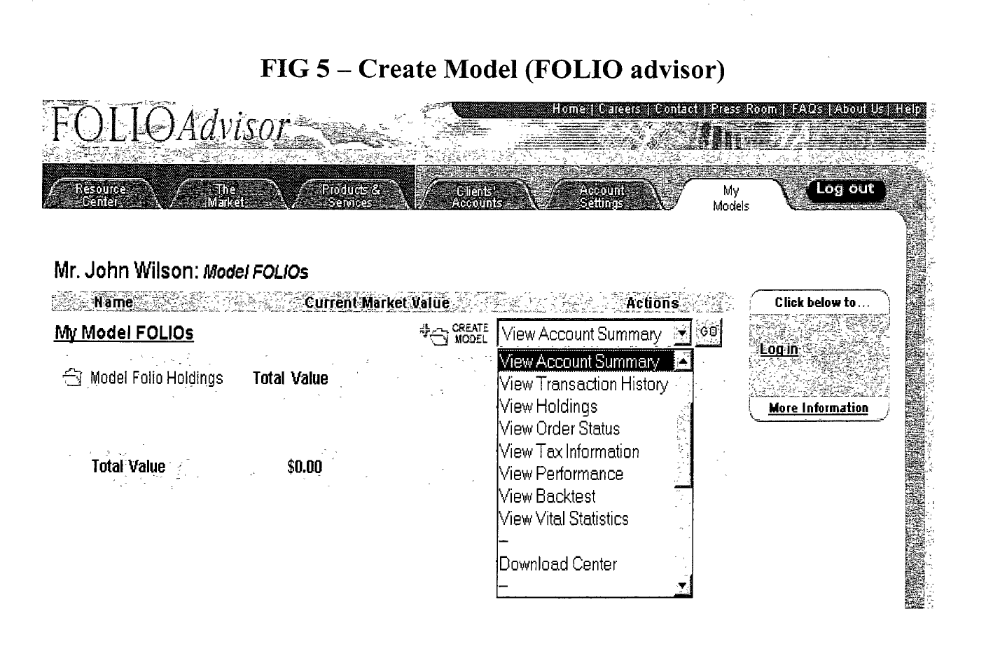

The model manager logs in at www.folioadvisor.com, after which the system displays the “My Models screen” with no available models. See FIG. 5, which shows the user's screen 50 for a manager. Multiple folios may be accessed through this screen by clicking on the links (e.g., the “My Model FOLIOs link or by selecting one of the commands from the displayed drop down menu). A few modifications to the user screen may be employed. For instance, the tabs may be conditional upon account type. For example, Investment Advisors would see the Clients' Accounts and Account Settings tab only, Model Managers would see the My Models and Model Settings tabs only, and hybrid users should see all. Moreover, the dropdown menu may be replaced with small icons for creating a model, modifying a model, and synchronizing a model. The rest of the functionality could then be accessed from the account/model summary screen (not shown).

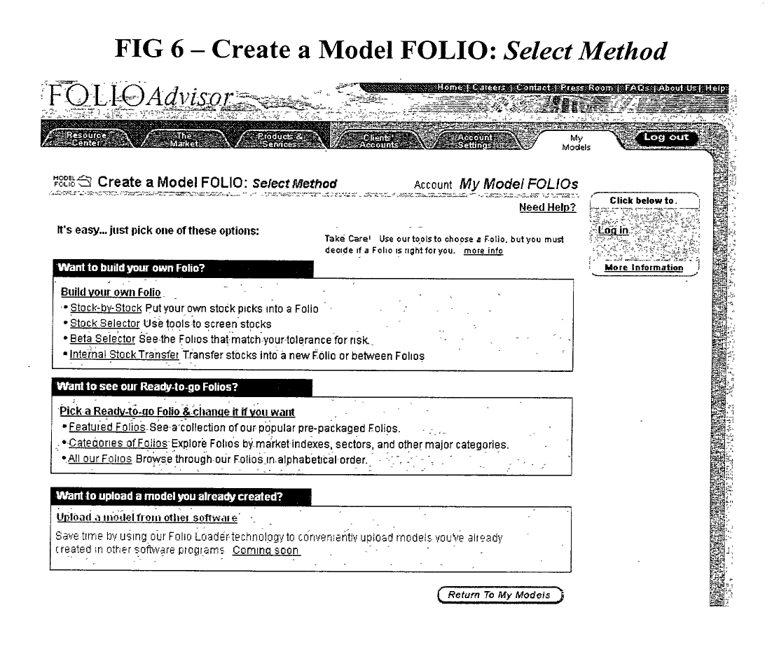

Next, the model manager selects “Create a Model FOLIO.” See FIG. 6. This screen enables the user to create a model folio in one of three ways: (1) build a folio 61; (2) Select a Ready-to-Go folio 62; (3) load a model portfolio from spreadsheets and other software programs 63.

Within the build your own section 61, there are four possible methods. In the first instance, the user may individually select stocks to be included in the model folio. Alternatively, the user can use certain tools to screen stocks, such as market capitalization, type, sector, etc. A third option provided is to employ a beta selector, which screens stocks based on a user's given level of risk relative to the market. Lastly, one may internally transfer stocks from another folio.

In the Ready-to-Go method 62, the user can select featured folios, categories of folios, such as aggressive, conservative, technology specific, etc., or browse through all folios.

In the upload method 63, the user can upload a folio from commercial software programs, such as Excel, Quattro Pro, Quicken, to name only a few.

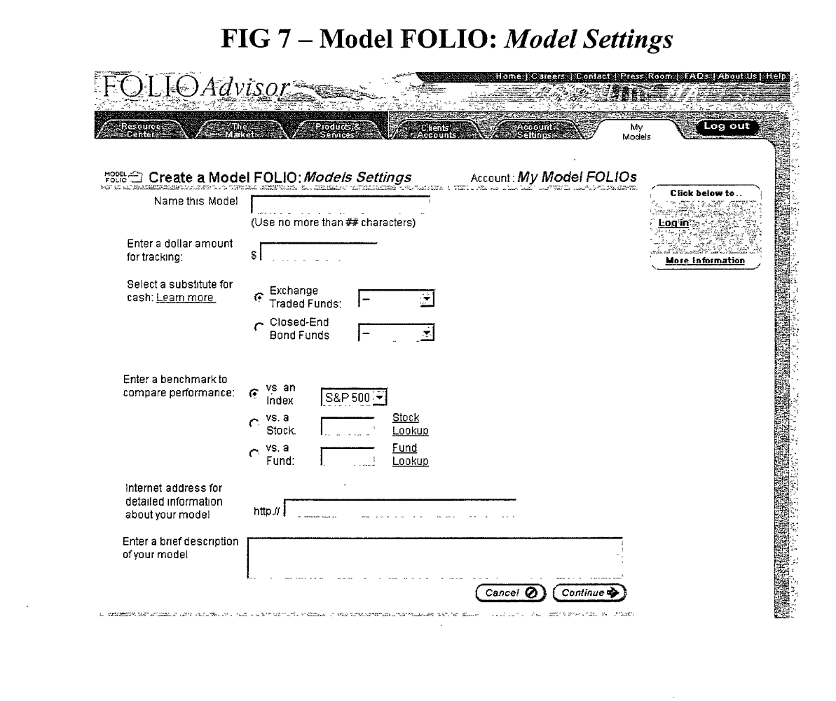

In this example, the model manager selects the first method to “Build your own Model” 61 by clicking on the hyperlink therein, which takes the model manager to the screen shown in FIG. 7. This screen 70 includes fields for name 71, dollar amount (for tracking purposes) 72 and a cash substitute 73, 74 (e.g., two options provided—Exchange Traded Funds (ETFs) or Closed-End Bond Funds) Within each of the options for cash substitutes there are drop down menus (not shown) from which a user may select specific cash substitutes, e.g., ETFs or Closed-End Bond Funds. Other cash substitutes are also possible, and the ones listed herein are merely examples.

Additionally, there is the ability to select a benchmark 75 against which the model's performance will be compared. For example, one can compare the model against an index, a drop down menu of which is provided, a stock (e.g., a field to enter the stock symbol is provided), or a fund (e.g., a field to enter the fund symbol is provided).

If the model manager wants to provide additional information about the model to his/her subscribers, the model manager may do so by creating a web site with this information and listing the Uniform Resource Locator (URL) in the field 76 provided in screen 70. An Internet address field 76 allows Model Managers to input a Uniform Resource Location (URL), which lists where a user can lookup further information regarding their model. A link to this URL may be displayed when the Account Manager views the available models (e.g., located where the “stock details” link is on the retail site).

A field 77 is also provided in which the user may enter a brief description of the model.

In this example, the model manager decides to invest $100,000 in his/her “tracking” model, names the model the “Aggressive” model, selects his/her cash vehicle, writes up a brief description of his/her new model and selects prepare order from the “Create a Model: Model Settings” screen.

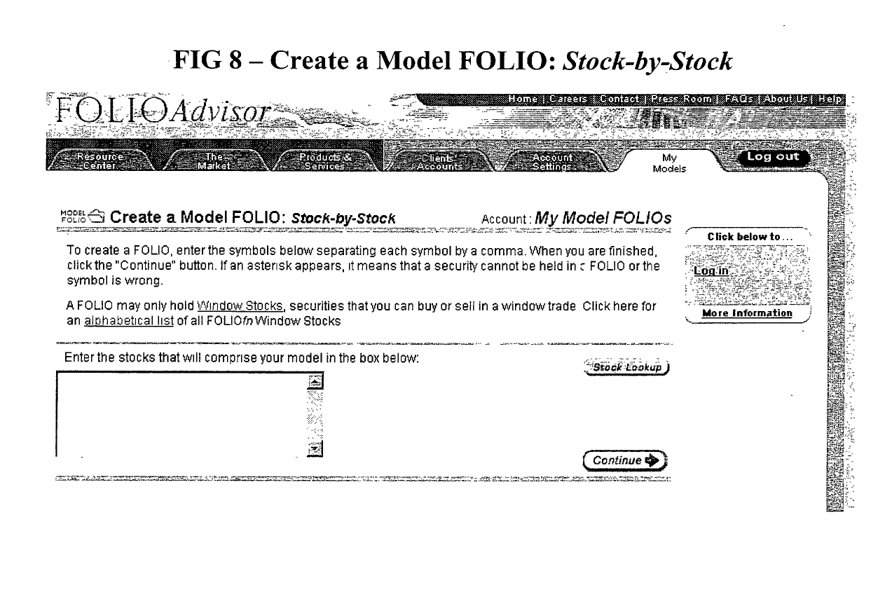

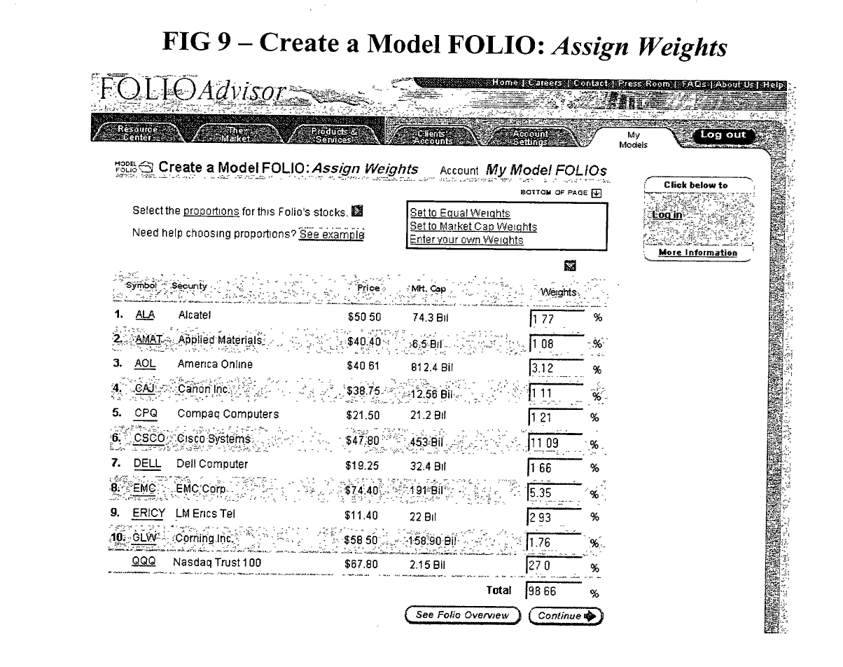

Upon clicking of the continue button, and satisfaction of the error check on the data, the user is presented with the screen 80 in FIG. 8. This screen 80 includes a field 81 into which the user can enter many stock symbols. A list of stocks available for selection can be opened by clicking on a link of alphabetical list 82 of all FOLIOfn window stocks. A stock symbol lookup link 83 is also provided via which a user can search for a stock by name and obtain its associated stock symbol. In this example, the model manager enters the stock ticker symbols that will comprise this model on the “Stock-by Stock” screen. Clicking on the continue button, and satisfaction of a system error check of the stock symbols, presents the user the screen 90 shown in FIG. 9, which is the “Create a Model: Assign Weights” screen. The model manager then inputs weights for the individual securities.

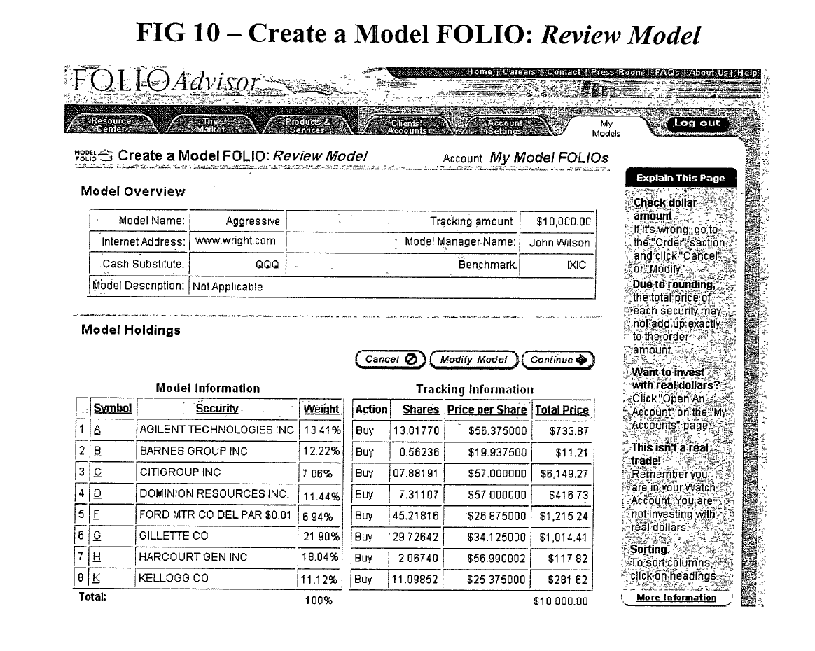

FIG. 9 lists the stocks selected in screen 80 of FIG. 8, their current price, their market capitalization, and includes a field 91 into which the manager can input a weight. The weights must add to 100 percent, otherwise the system will not accept them. In addition, the “cash” position (in this case the QQQ NASDAQ Trust 100) is visibly separated from the rest of the holdings; however, its position is incorporated in the total. A java script may be used to increase or decrease the cash position inversely proportional to the securities' values (i.e., as the user increases a particular investment by 1% the cash position weighting is automatically reduced by 1%.) The user is also able to assign weights equally or based on market capitalization, as well as individually assigning the weights. Once the weights are entered, the user clicks on the continue button, which takes the user to the screen 100 in FIG. 10, assuming the error check on the weights adding up to 100% is satisfied.

Turning to FIG. 10, the model manager then reviews his model and selects to create model from the “Create a Model: Review Model” screen 100, which lets the user view the selections received by the system for a last minute check before implementing them. A model description section may be added that is capable of displaying paragraphs of text—cell expands (e.g., downward) when necessary. A link for more information, the cash substitute, and the benchmark chosen on the model settings screen may be provided. The Holdings section (Order) may have the model's weights included. This section may be broken down into two visibly separate sections. One contains model information and the other contains tracking data. The sum of the dollar value and percent weighting are displayed at the bottom of the screen. The percent must equal 100.

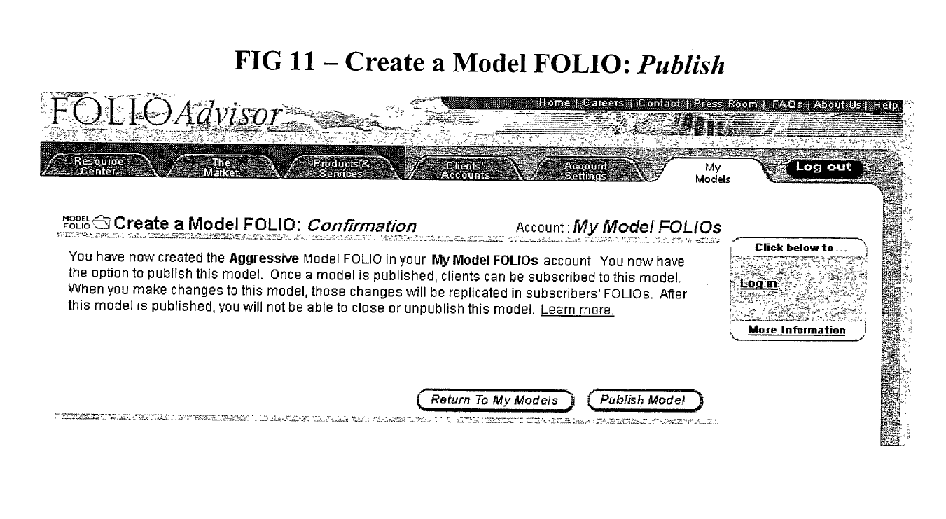

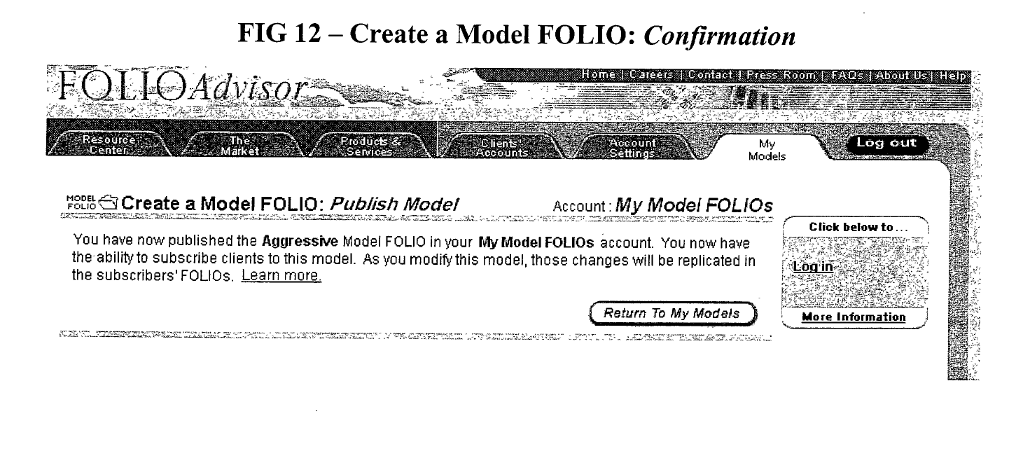

If the manager is satisfied with the model, clicking on the continue button and satisfaction of any error tests on the data takes the user to the screen 110 in FIG. 11, via which the model manager will have the option of publishing this model for subscription (e.g., within his firm or to outside the firm, including users of the portfolio manager system). Screen 110 prompts the user as to whether the user wishes to publish the model. Clicking on the “Learn more” button sends users to a help page that will differentiate published and unpublished models and provide information about the subscription process. If the manager publishes this model, he will be given another confirmation screen 120 (see FIG. 12).

Finally, the model manager then logs off the site via FIG. 12, for example, which includes an informational field telling the user that his changes will be reflected in subscribers' accounts, and permitting the user to return to his or her model folios.

The advisor and his firm now have one model available for subscription in his model set. The clients of his/her firm will now be able to subscribe to this FOLIO.

The above-described embodiment can be used to set up an investment portfolio for an investment club as well, or any other group. The following example sets forth this capability.

### EXAMPLE 2

### Investment Club Manager Creates the Club Model FOLIO

In this example, an investment club has just started using the FOLIO Club product. The investment club held a meeting, in which they decided to create their club model FOLIO beginning with the 30 stocks that comprise the Dow Jones Industrial Average. The investment club manager is responsible for creating their model. In general, the investment club manager logs into the system as the model manager. He selects to use a RTG FOLIO for the investment club's model. He names the model, provides a brief description, and enters a fictitious dollar value to track the price fluctuation of the club's model. Then he reviews and creates the model. In this example, the user is the Investment Club Manager. We shall assume an investment club representative has opened an account with FOLIOfn, and therefore, he/she has been set up as the model manager.

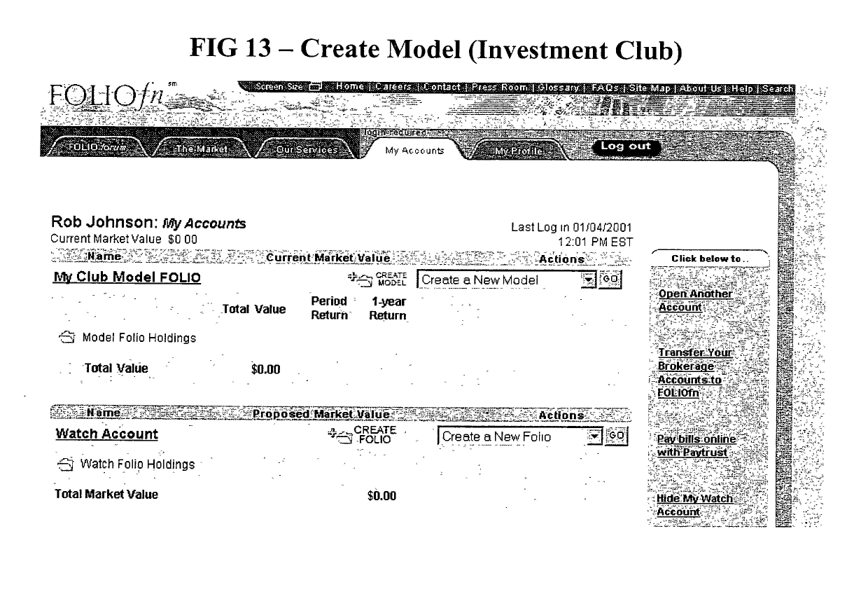

First, the investment club manager logs in at www.foliofn.com, after which the system displays the “My Club” screen 130 without a model, which is shown in FIG. 13. Screen 130 enables the user to access other screens to create a model folio. The club manager has a separate account for each of the following: Watch FOLIO(s), Club Model FOLIO(s) and Club Subscriber FOLIO(s). Any subsequent Individual, Joint, IRA, etc. needs its own account.

On screen 130, the, investment club manager selects “Create a Model FOLIO” by clicking on the GO button 131 next to the command to “create a model folio.” This takes the club manager to a screen similar to the screen 60 in FIG. 6.

Next, the investment club manager selects to “Pick a Ready-to-go FOLIO,” from the “Create a Model FOLIO: Select a Model” screen 60 (FIG. 6). This takes the club manager to a screen (not shown) that lists the ready to go folios, from among which the club manager selects the RTG folio.

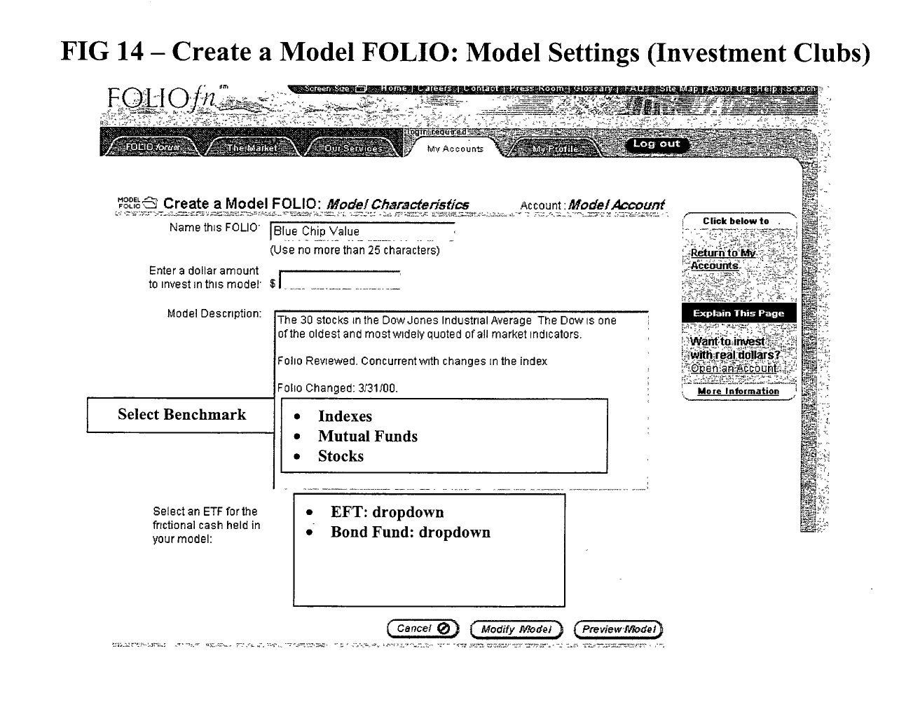

This takes the club manager to the screen 140 in FIG. 14. Screen 140 includes fields for name 141, dollar amount to invest 142, model description 143, benchmark 144, cash substitute 145 (as described with reference to Example 1). The investment club manager selects to invest $100,000 in his/her model, names it the “Blue Chip Value” FOLIO, selects a cash sweep vehicle, and selects a benchmark index. The description text box comes pre-filled with a synopsis for RTG FOLIOs.

Upon clicking on the preview model button, the system performs an error check on the name of the FOLIO and the cash fund. If option is not available, the box is marked with a star and the system returns an error message to the user. If the dollar amount is left blank, system uses a default, e.g., $1 OK. If the model description is left blank, the system defaults to Not Applicable.

The investment club manager then reviews his model in the preview screen (not shown), and selects to create model from the “Create a Model: Review and Publish Model” screen (not shown). Finally, the investment club manager logs off the site.

The investment club now has a model set up for their account. The members of his/her club will now be able to subscribe to this FOLIO, as described below.

Managing Models

The second step for the model manager is the management of the existing models. The modifications that are made to these models are then replicated throughout the subscriber FOLIOs. The model manager is responsible for making any necessary alterations to the model. Furthermore, the money manager is the only one with the ability to enact changes on the models. The subscriber FOLIOs do not have weights, but rather rely on the model FOLIO for weights. Once changes are made to the model, the system automatically reproduces the changes within the subscriber FOLIOs. However, the Investment Advisor may have the ability to review the trades. These orders will be placed automatically. Alternatively, account managers may review the trades before they are placed in a semi-automatic manner. In yet another alternative, account managers may be able to sync “on-demand.”

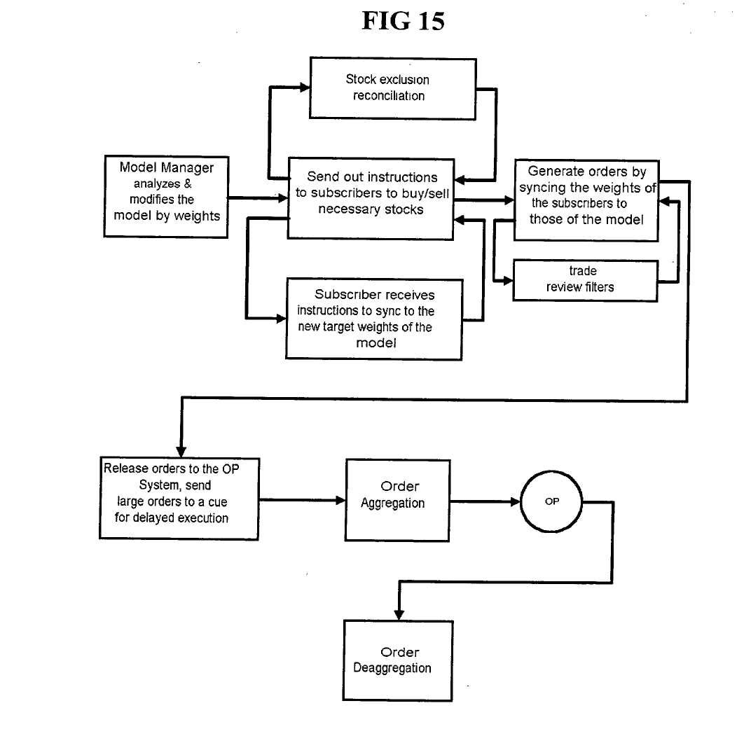

The frequency of these reviews will be variable (i.e., each trade, filtered trades, etc.) depending upon the needs of the user. FIG. 15 depicts a high level overview of the sync process 150.

First, the manager analyzes and modifies the model by weights 151. These changes cause instructions to be sent to the customers to buy or sell the necessary stocks 152. The customers perform the stock exclusion reconciliation 153, if appropriate, and receives instructions to sync to the new weights 154. Orders are then generated by syncing the weights of the subscribers to those of the model 155. In addition, trade filters may be employed to automatically review the trades 156. The orders are then released to the order processing system 157. Alternatively, the orders may be delayed in cases of large orders. The orders are then aggregated and executed 158. The order processing receives the trade results 159 and deaggregates them and forwards the necessary trade information to the customers 149.

The present invention makes modifications to ones model folio simple. The changes are then automatically replicated to the subscribers' to the modified model folio. The next example sets forth this capability.

### EXAMPLE 3

### The Model Manager Modifies a Model FOLIO

In this example, the model manager has been using the FOLIO Advisor product to design and manipulate models for subscriber clients of his/her firm. The model manager has researched a number of Biotech companies and decided to add a few to the Aggressive Growth model. As well he/she has decided to remove a number of other securities.

In general, the model manager logs into the Advisor site. He/she goes to the Aggressive model and makes modifications to it. He/she reviews the changes and executes them. The order is placed and moments later the model is updated. The modification instructions are then sent to the model's subscriber FOLIOs. In this example, the user is the Model Manager. We shall assume the model manager holds an account with FOLIO Advisor in which he or she has created one the Aggressive model, which has existing subscriber members.

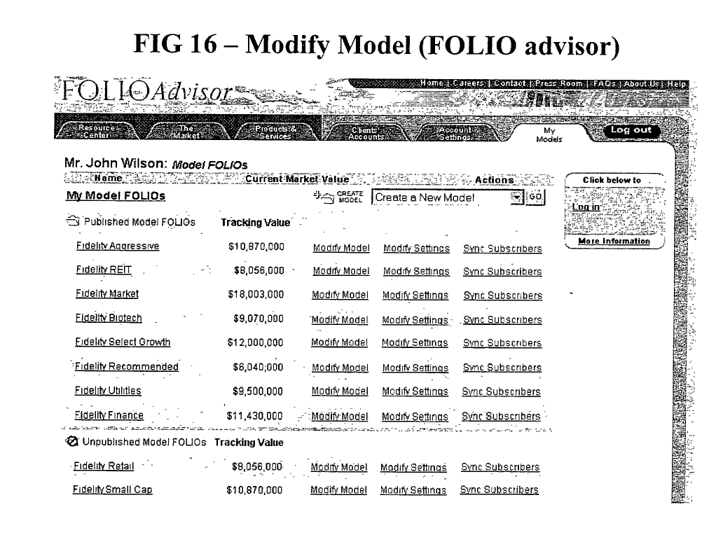

As always, the model manager logs in at www.folioadvisor.com, after which the system displays the My Models screen 160 (FIG. 16) with multiple available models. The model manager selects “Modify Model.” Screen 160 lists the models belonging to the model manager—both the published and unpublished models. Each model has an associated fictitious dollar amount for tracking purposes. The model manager can select any model listed, modify the settings for that model, or sync the subscribers to the model folio. The tracking value represents the fictional dollar amount initially assigned to the model. The dropdown menu may be removed; rather, there may be two links via icons, for example. Selecting Modify Model—takes user to the weights screen. Selecting sync takes users to the preview order screen to sync with target weights. The modify settings link may be on the model summary screen, which is accessed by clicking on the model name. This link should take users to the model settings screen.

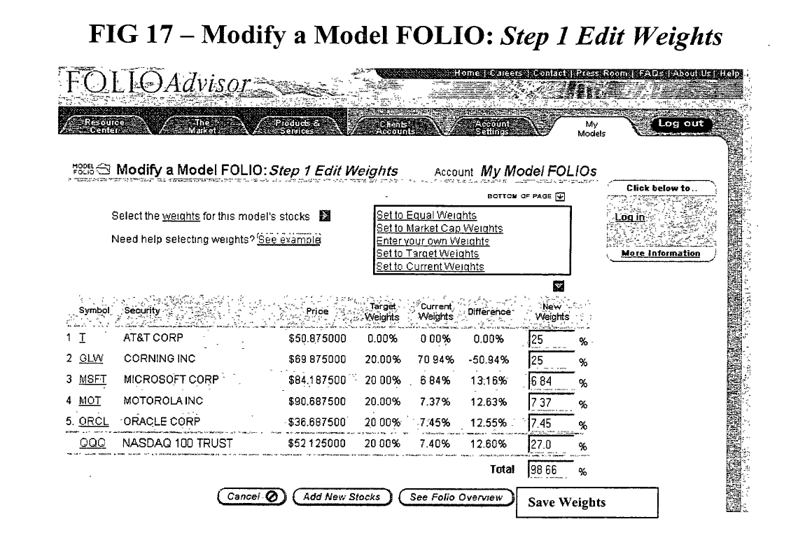

The model manager selects the modify model next to the Aggressive model, which takes the manager to screen 170 shown in FIG. 17. The model manager then modifies the target weights of the Aggressive model. The system performs an error check to verify 100% weight allocation. The weight allocation boxes are prefilled with the target weights so that the Model Manager is easily able to rebalance the model. The system alerts the manager to the fact that once these weights are saved, there is no way to get back to old target weights other than manually entering them. The links allows the user to automatically set the weights as desired. The user can select equal weights, weights based on market capitalization, his own weights, the target weights or the current weights.

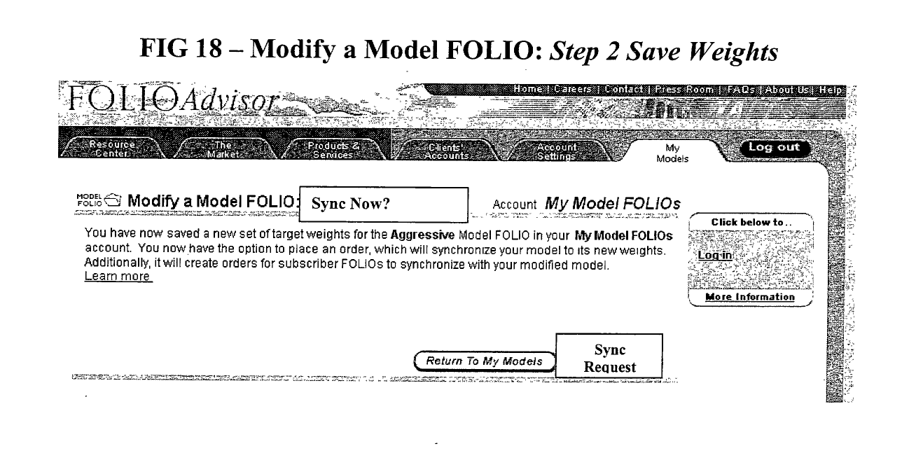

The model manager then clicks on save weights on screen 170, which takes the manager to screen 180 shown in FIG. 18. This screen provides the user the option to return to my models or create a sync request. At this point, the user has saved a new set of weights. They now have two options: (1) Return to the My Models screen & do nothing; (2) Place a Sync Request—this option will take the user to the preview order screen (not shown).

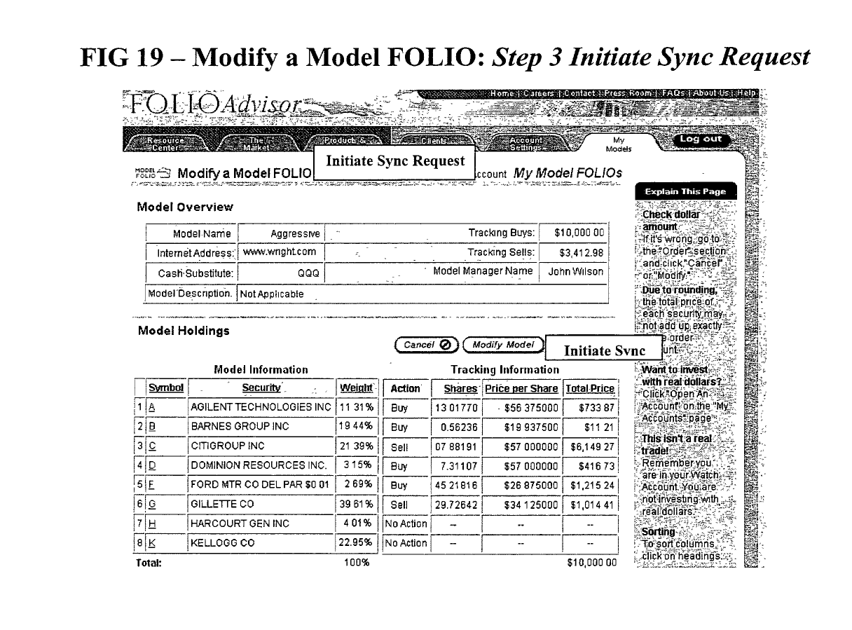

The model manager opts to create a sync request. The model manager then reviews his changes and selects to “initiate sync” (screen 190, FIG. 19). The model information is separated out from the tracking information. All securities are listed. If they are not being bought or sold, “no action” appears in the action column and “-” appears in other tracking columns.

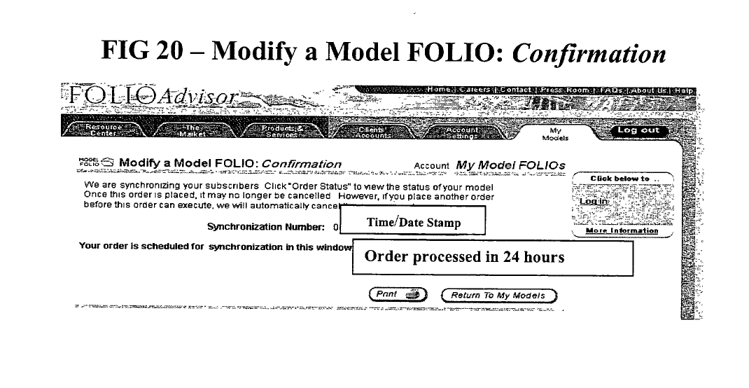

The model manager receives an order confirmation, as shown in FIG. 20. The sync time/date stamp replaces the order number. There is content to explain the order will be processed over the next 24 hours.

Finally, he/she logs off the site. The Aggressive model was modified with new weights. The system will now send subscribers instructions to sync with the new target weights of the model.

### EXAMPLE 4

### The Model Manager Deletes a Model FOLIO

In this example, we shall assume, the model manager has been using the FOLIO Advisor product to create and modify Aggressive model. The model manager now decides that he wants to delete this model.

In general, the model manager logs into the Advisor site. He/she goes to the Aggressive model summary and selects to View Model Settings. He/she deletes the model. The User is this case is the Model Manager. The model manager currently holds an account with FOLIO Advisor in which he or she has created one the Aggressive model, which does not have any existing subscriber members.

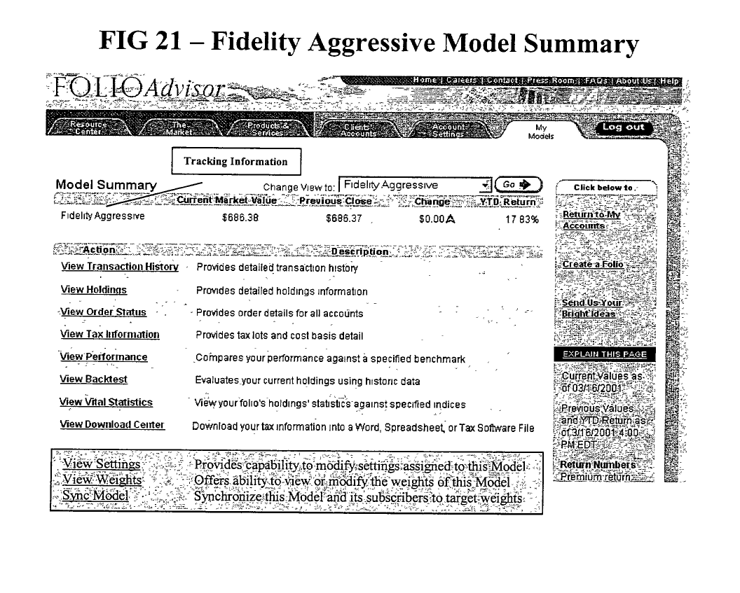

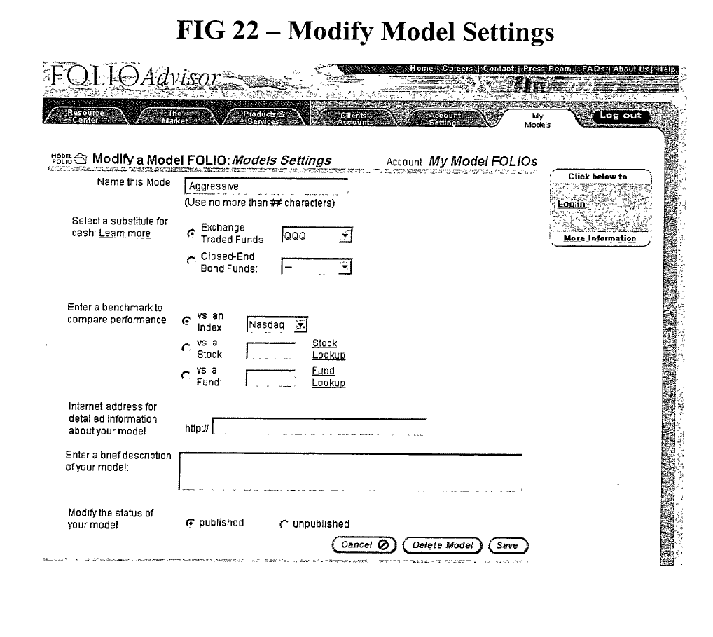

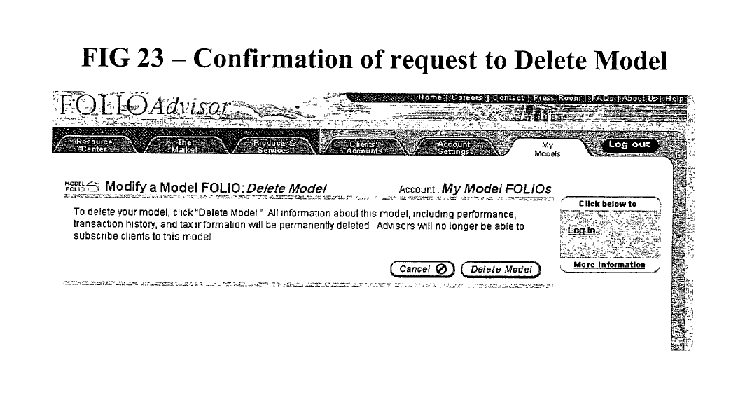

The process proceeds as follows. First, the model manager logs in at www.folioadvisor.com. The system displays the My Models screen with multiple available models (see FIG. 16). The model manager selects the “Aggressive” model, which takes him to the screen 210 shown in FIG. 21. The model manager then selects to “View Settings” from his Model Summary screen, which takes him to the screen 220 as shown in FIG. 22, which enables the model manager to modify certain settings. In this case, the model manager elects to “delete model” and the system confirms that the manager wants to make the change he/she has requested, via the confirmation message shown in screen 230 in FIG. 23. Finally, he/she logs off the site.

After this process, the Aggressive model is deleted and is completely wiped out of the database. The user may unpublish or delete any model that does NOT currently have subscribers. If the user modifies the cash sweep vehicle, it will be placed in his model as the cash sweep vehicle with a 0% weighting.

Once a user has been using a model folio to invest, the actual holding weights will vary from the desired weights due to fluctuations in the share prices of the underlying investments. The present invention makes rebalancing back to the original weights simple, as shown in the next example.

### EXAMPLE 5

### Investment Club Manager Updates the Club Model FOLIO

In this example, an investment club has been using the FOLIO Investment Club product as a trading platform for their organization. The club currently holds the 30 stocks in the Dow, and they now would like to rebalance their model. The investment club manager is responsible for executing trades, which will in turn send instructions to the subscribers' FOLIOs.

In general, the investment club manager logs into the system. He simply selects to sync the model. He reviews the changes and selects to initiate the sync request. The user in this case is the Investment Club Manager.

We shall assume, the investment club holds an account with FOLIOfn. The investment club manager has created a model FOLIO for the club, and the members have subscribed to it.

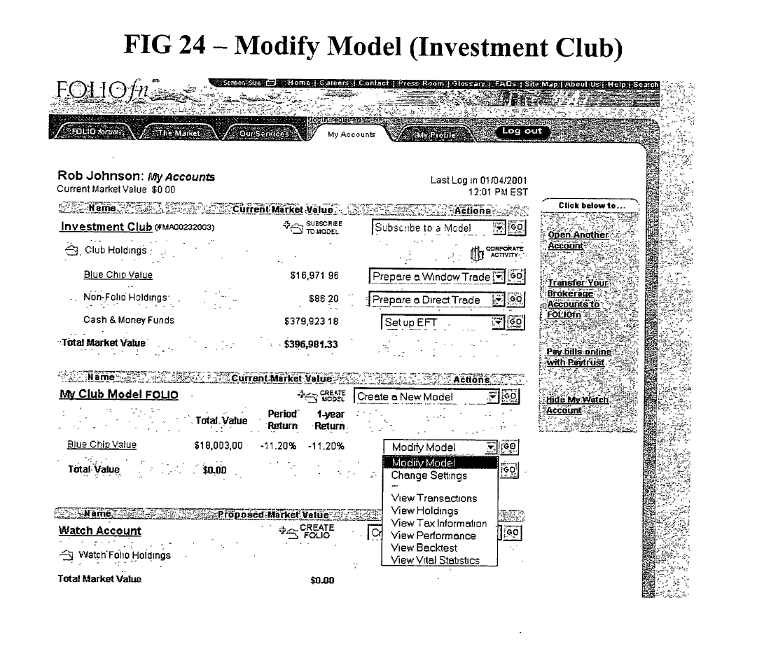

The process proceeds as follows. The investment club manager logs in at www.foliofn.com. The system displays the My Club screen 240 with the club model displayed, as shown in FIG. 24. The manager's club account is differentiated from the model account. It displays any necessary corporate actions, offers the ability to subscribe to model FOLIOs, and Enable user to place window trades on their version of the model. The investment club manager selects to “Sync Subscribers.” See FIG. 16. The investment club manager reviews his changes on the “Modify a Model FOLIO: Initiate Sync Request” screen (FIG. 19) and selects “initiate sync.” Finally, the investment club manager logs off the site.

After this process, the investment club model has now been rebalanced to its target weights. The subscriber FOLIOs will now be sent instructions to sync to the weights of the club model.

Institutional Subscription Process

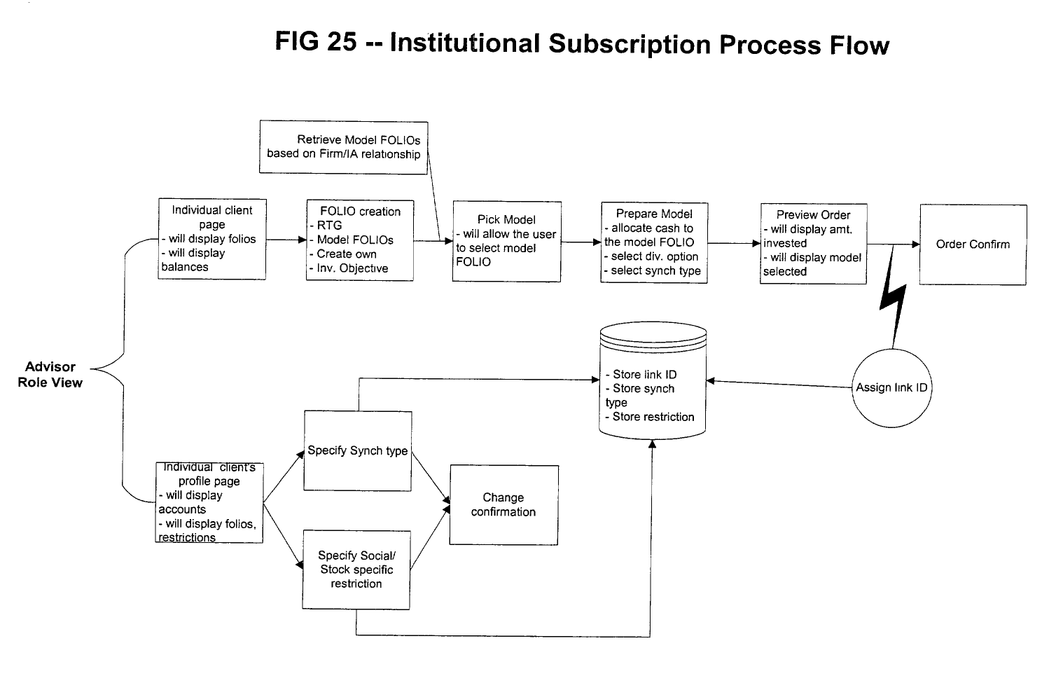

Turning to FIG. 25, shown therein is a process 250 for subscribing to a model folio in an institutional setting, in which an investment advisor is managing the investment. The top portion 251a-g shows the activities related to the owner of the investment, whereas the bottom portion 252a-f shows the activities related to the manager of the model folio. The individual client page displays the folios and balances in those folios 251a. The individual selects their investments 251b or selects a model folio from among those model folios retrieved based on the firm/IA relationship 251c. A screen enables the user to pick a model folio 251d. The investor allocates cash to the model folio 251e. A preview of the order is displayed to the investor 251f. All trading orders are confirmed 251g.

The advisor can display each client's profile 252a, specify a sync type 252b, social exclusions 252c, and receives confirmation of any changes 252d. The link ID and synch type and social exclusions are stored in the system database 252e. The assignment of a link ID 252f permits control of the trading orders submitted by the investor.

Retail Subscription Process

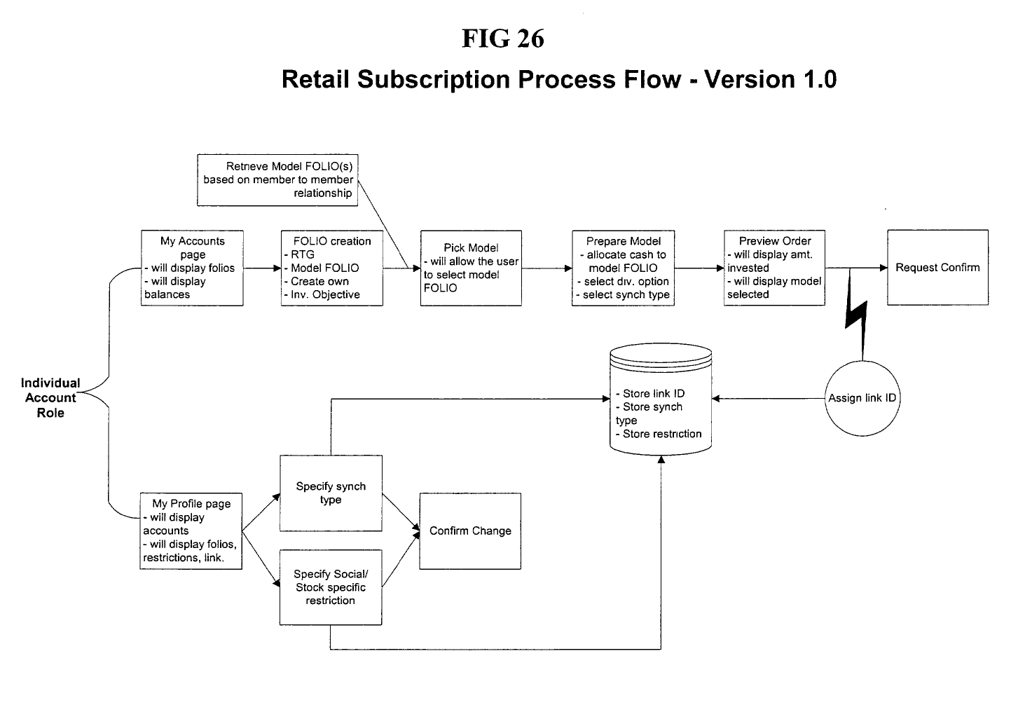

Turning to FIG. 26, shown therein is a process 260 for subscribing to a model folio in a retail setting, in which the individual is managing his or her investment. The top portion 261a-g shows the activities related to the owner of the investment, whereas the bottom portion 262a-f shows the activities related to the manager of the model folio. The individual client page displays the folios and balances in those folios 261a. The individual selects their investments 261b or selects a model folio from among model folios that are retrieved based on the member to member relationship 261c. A screen enables the user to pick a model folio 261d. The investor allocates cash to the model folio 261e. A preview of the order is displayed to the investor 261f. All trading orders are confirmed 261g.

The individual can display his or her profile 262a, specify a sync type 262b, social exclusions 262c, and receives confirmation of any changes 262d. The link ID and synch type and social exclusions are stored in the system database 262e. The assignment of a link ID 262f permits control of the trading orders submitted by the investor.

Subscribing to Model FOLIOs

On the other side of the process is the role of the Investment Advisor. Their first step is to subscribe clients to a specified model. The model manager creates a model FOLIO to which certain other users will be able to subscribe. Once a model FOLIO has been created and published, it is available for review and subscription to any client whose Investment Advisor has access to that model.

The subscription process flow varies from user to user. Advisors have the ability to subscribe their clients and perform other administrative duties. The advisor's clients are only able to view their accounts—not the entire model base. Investment clubs have a more simple subscription path. Club members are able to subscribe themselves to the model FOLIO. This process removes the additional third party involved in the advisor process.

Additionally, there are various types of synchronization schedules that the user may choose. Fully automated sync causes the subscribed accounts to be updated with the model FOLIO's new holdings and weights once the model manager initiates a sync request. This schedule does not require the advisor's participation in the synchronization process.

The on-demand option allows the advisor to sync his or her clients to a model upon request. This is also to be known as a ‘pull’ model whereas the others are characterized as ‘push’ models because in this instance, the advisor pulls the sync to his subscribers rather than the model manager pushing out the sync request.

Review and release synchronization enables the investment advisor to preview orders before they are executed and prevent them, when necessary. The advisor has two trade review options: all trades and filtered trades only. If the advisor selects the filtered trades only option, he or she only has to review and release trades that have been kicked out because they have violated some sort of restriction (e.g., excluded stocks, tax filters, etc.) while the remainder of the trades will be executed automatically.

The stock exclusion process can be fully automated. Thus, when a model manager purchases a stock that has been excluded in an individual client's account, the system kicks out that stock from the order and reallocated the funds across the remainder of the folio order. The advisor may log into the system afterward and reinvest those funds as desired.

### EXAMPLE 6

### Advisor Subscribes Clients to a Model

In this example, an advisor has been using the FOLIO advisor product to manage money for his/her clients. The advisor would like to begin using the FOLIO sync product to subscribe clients to models published within his/her firm.

In general, the Advisor logs into site, opens customer account, selects the appropriate model, and subscribes his/her client to that model by placing an order. In this example, the user is the investment advisor.

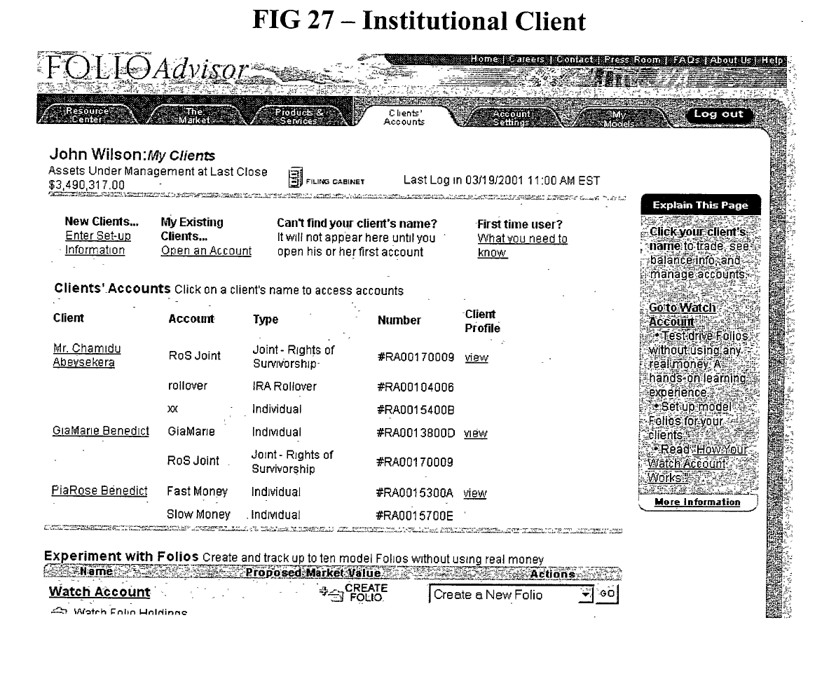

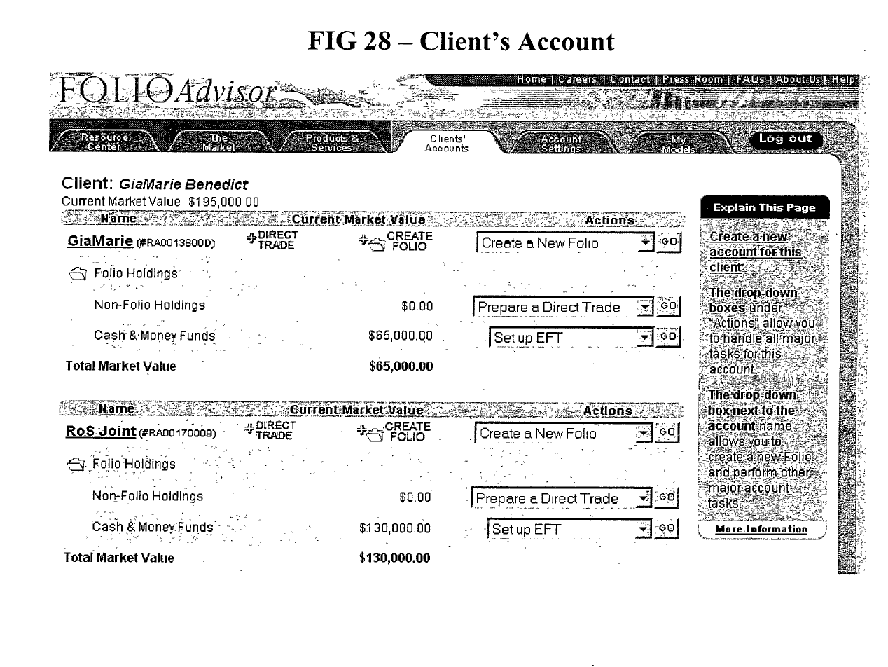

We shall assume the Advisor holds an account with one or more funded client account. The process proceeds as follows. First, the Advisor goes to www.folioadvisor.com and logs into his account. The system displays the “My Clients” screen 270, as shown in FIG. 27. The Advisor drills into a client's account by clicking on their name, which takes them to the screen 280 in FIG. 28.

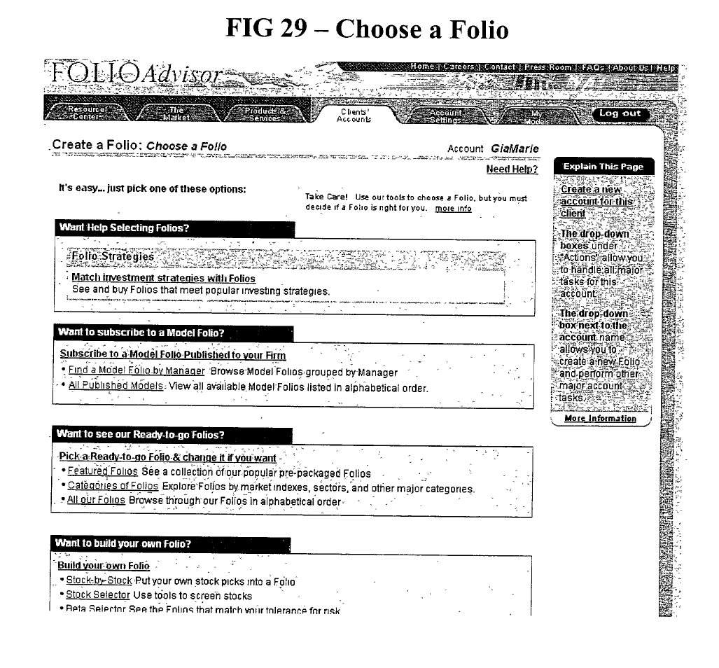

The Advisor selects starts the subscription process. The process itself will resemble a “Create a FOLIO” process where the advisor would choose between ready to go folios, personally customized folios and more. When presented with screen 290 in FIG. 29, the Advisor selects the “model” option and picks from among the different available models. The advisor has the option to view the models listed alphabetically or an alphabetical list of model manager names. The heading link takes the advisor to the list of all the published models in his/her firm (same as the “All Published Models” link).

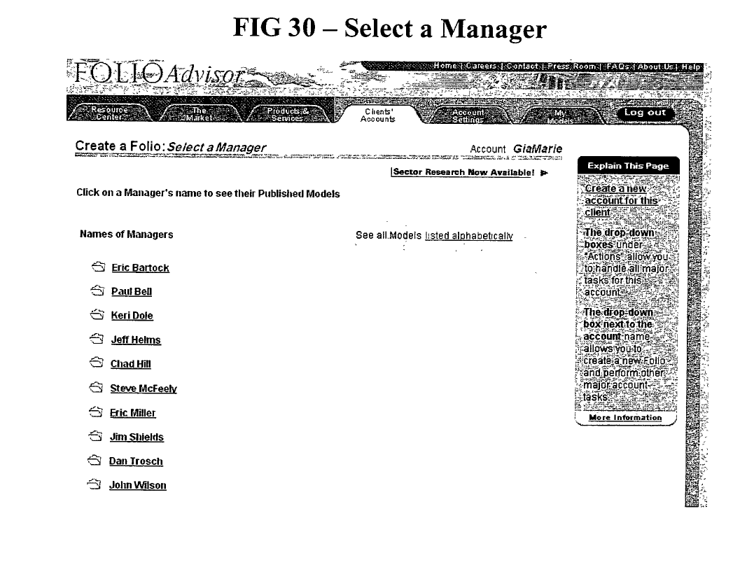

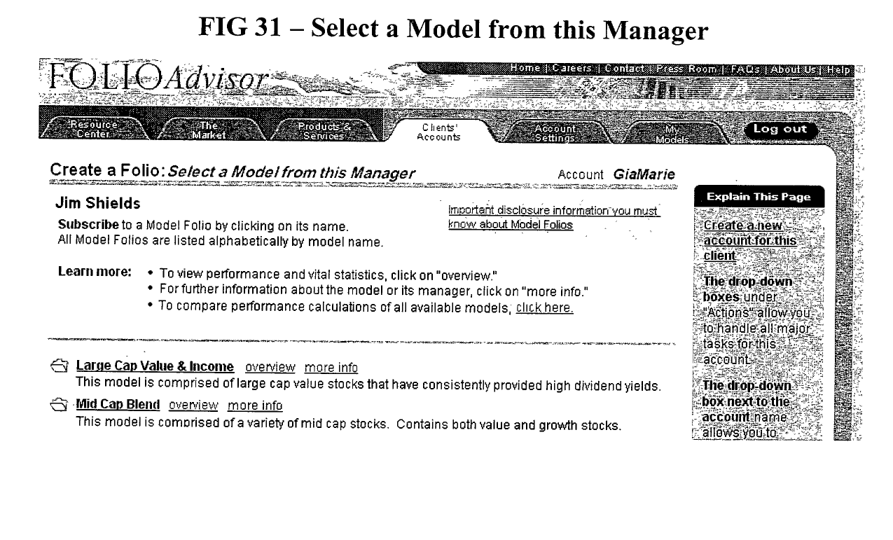

The system retrieves all applicable managed FOLIOs for that Firm/IA, which takes the user to the screen 300 shown in FIG. 30. Once the advisor selects a manager's name, the user is taken to another screen 310 with a list of all models that have been published to his/her firm by that model manager, as shown in FIG. 31. The “listed alphabetically” link should take the advisor to the list of all the models published to his/her firm.

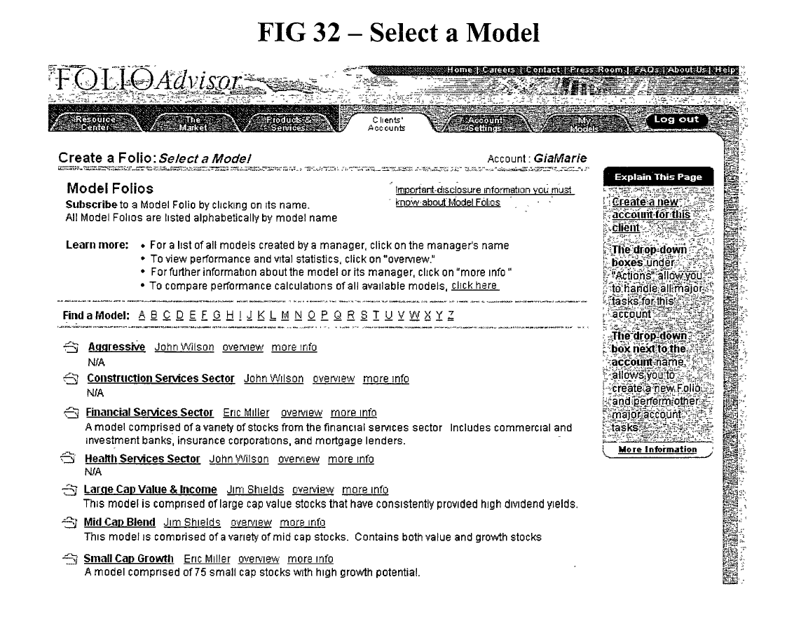

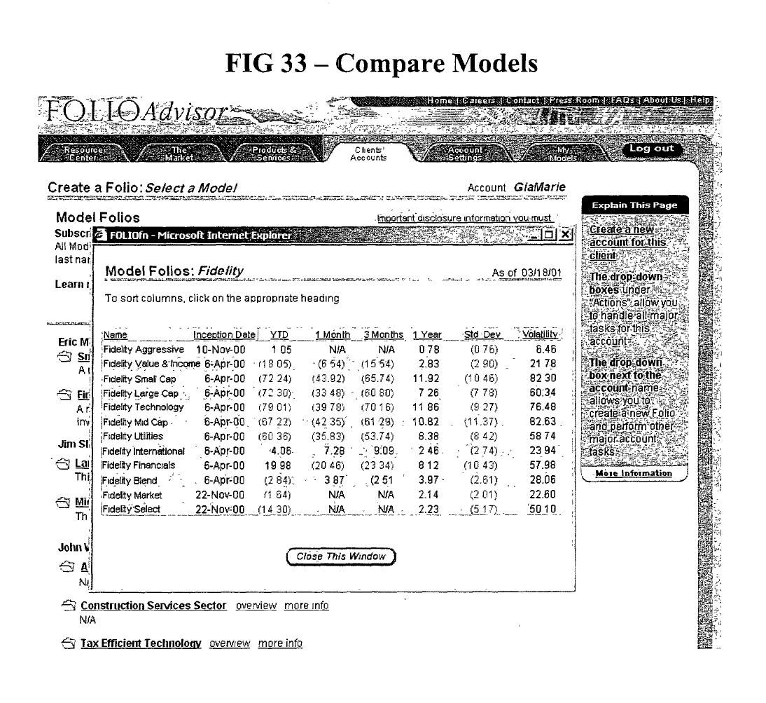

The advisor opts to compare performance figures for their firm's model set (see screen 330 in FIG. 33). The advisor selects the Aggressive model from the screen 320 shown in FIG. 32. The advisor sees all models published by members of his/her firm. These models are listed alphabetically according to the model name. The overview link provides current FOLIO overview information. The manager's name takes the advisor to the list of models published by that manager, as if the advisor had clicked on the manager's name from the “select a manager” screen. The more info link navigates the user to the URL specified by the model manager (if available) in a new browser. Additionally, a link is provided for “Disclosure Info” that displays the legal ramifications of owning a model FOLIO and what it means when you have an automatic or reviewed synchronization. The “Compare Performance” link pops up a performance screen of the models for the user to view.

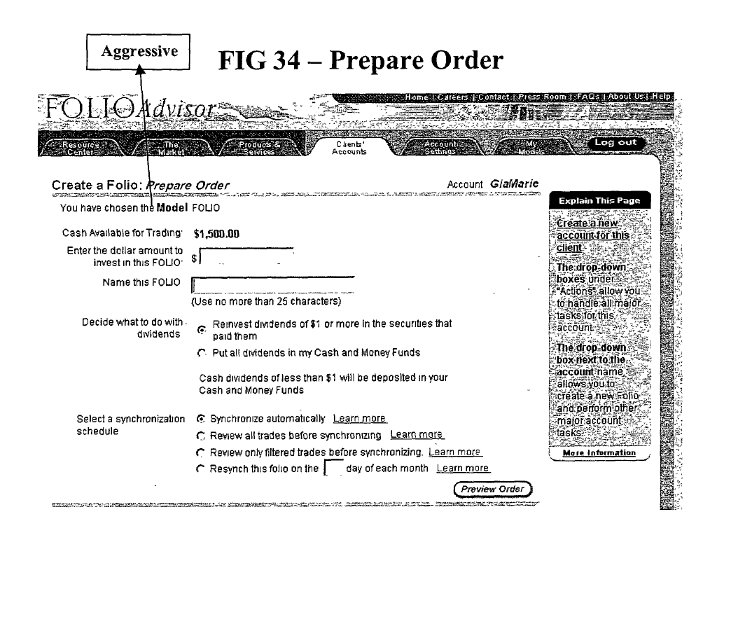

The Advisor then prepares the trading order (see FIG. 34) using screen 340. Once the model FOLIO has been selected, the user will then decide: what to do with dividends; the synchronization schedule; how much to invest; and the name of the FOLIO (should default to the name of the model). All current FOLIO options will be subscriber specific:

Dividend Reinvest v. Cash

Order Kick-out Limit

Tax Lot Selection method

Fund for cash.

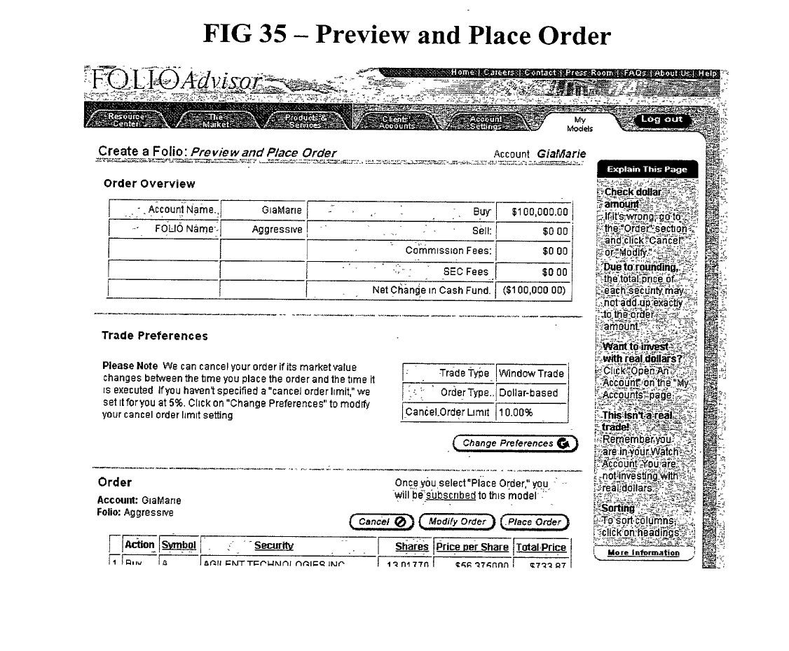

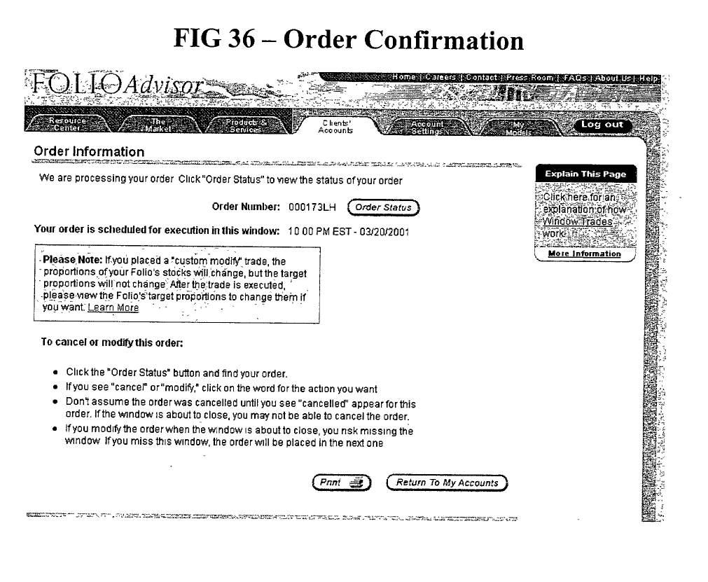

The system confirms proceeds to the Preview and Place Order screen 350 (see FIG. 35). The order kick out limit may be defaulted to 10% for subscriber FOLIOs. After placing the order, the system displays the order confirmation screen 360 (see FIG. 36). Once the advisor executes the trade, the system must perform the synchronization link from the model to the subscriber FOLIO. Thus each trade the model manager then makes should be replicated in the subscriber's account. The IA logs off the system.

The client is now subscribed to the Aggressive model. He/she now holds that FOLIO in his/her account.

### EXAMPLE 7

### Investment Advisor Unsubscribes a Client from a Model

In this example, an investment advisor decides to unsubscribe a client from one of his/her models. In general, the Advisor logs into site, opens client profile, and selects the ‘unsubscribe’ option. The user in this case is the Advisor. We shall assume the Advisor holds an account and has a client subscribed to one or more models.

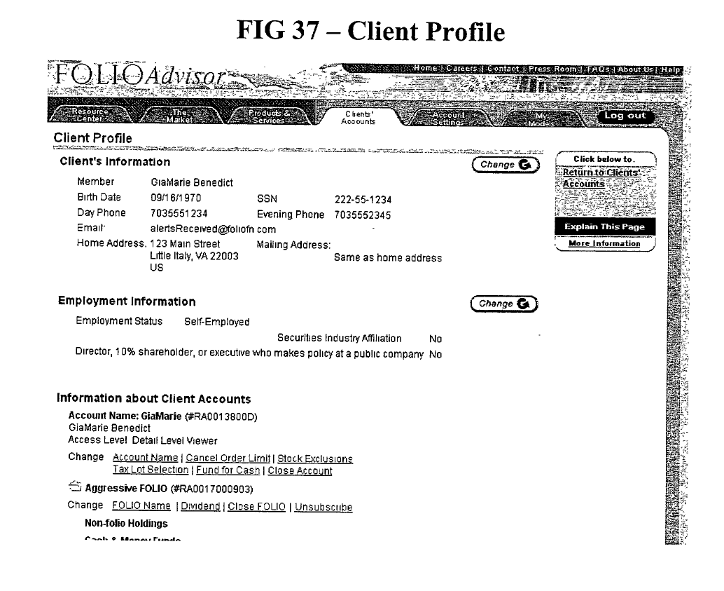

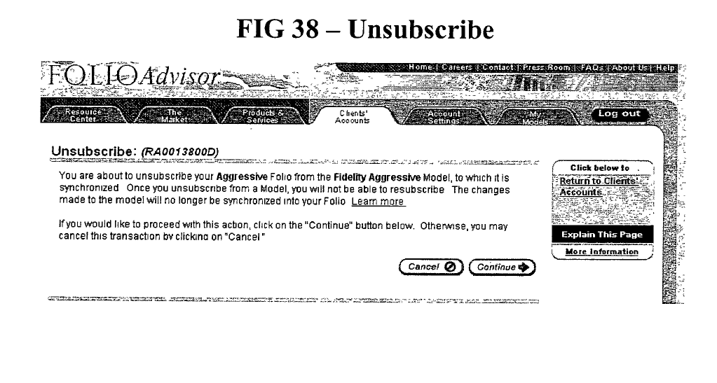

The process proceeds as follows. First, the Advisor goes to www.folioadvisor.com and logs into his account. The System displays the “My Clients” screen 270 (see FIG. 27). The Advisor drills into a client's profile by clicking on the “view” link, which takes him to the screen 370 shown in FIG. 37. The advisor selects the “unsubscribe” option, which takes him to screen 380 (see FIG. 38). The system prompts the advisor to be sure this is the action they intended to take. Additionally, the “learn more” link should tell them what it means to unsubscribe. Once a folio is unsubscribed, the FOLIO takes the model's target weights for its own. Modification to the model are no longer replicated into this former subscriber.

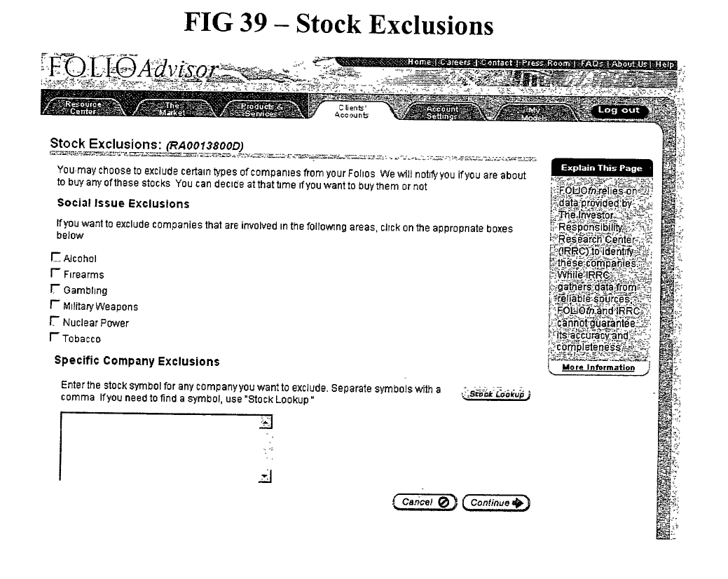

The advisor will then return to the client's profile screen, shown in FIG. 37. The advisor may also elect to edit other information from this screen 370, such as stock exclusions. Clicking on the stock exclusions link on screen 370 takes the user to the screen 390 shown in FIG. 39. If a stock exclusion is encountered when a sync order is placed, the system automatically removes the excluded stock and reallocates the funds across the rest of the folio order. The IA logs off the system.

The Client is now unsubscribed from the Aggressive model. He/she now holds that FOLIO in his/her account without a subscription link.

### EXAMPLE 8

### Investment Club Member Subscribes to the Club's Model FOLIO

In this example, a new investment club member is excited about opening an account at FOLIOfn. He adds model to the account and makes his first investment in the club's latest Model FOLIO.

In general, the Club member logs in to site, subscribes to the club's model FOLIO and then logs out. In this case, the user is the Investment Club Member. We shall assume there exists a Funded investment club account.

The process proceeds as follows. The Investment club member goes to www.foliofn.com and logs in. The system displays the “My Accounts” screen. The club member starts the subscription process. The process itself will resemble the “Create a FOLIO” process where the club member would choose between ready to go folios, personally customized folios and more (e.g., the screen 290 in FIG. 29). The club member will select the “model FOLIO” options and pick from among the different available models for his investment club(s).

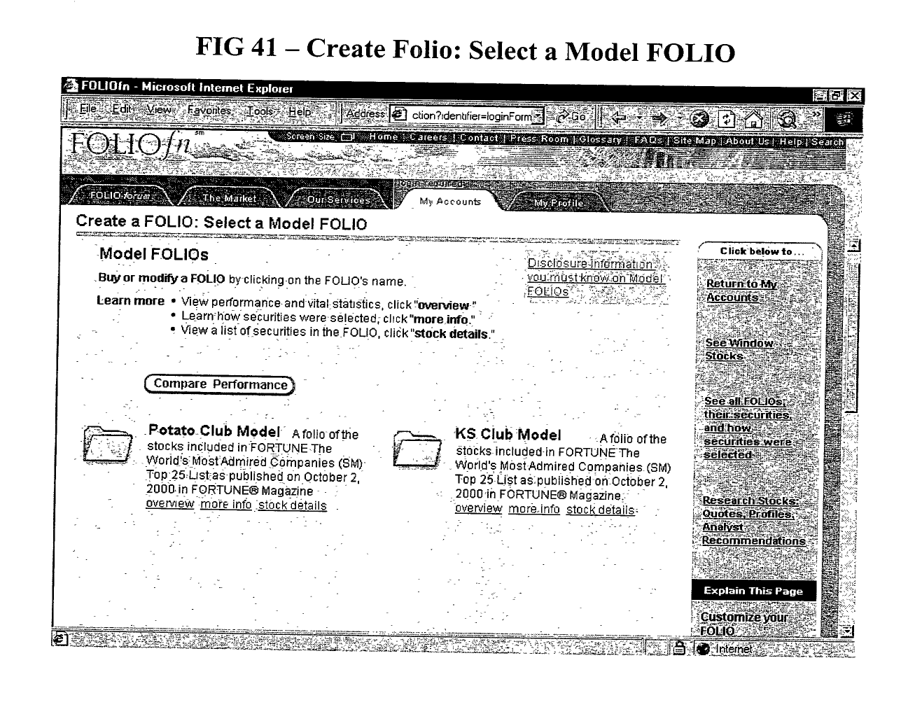

The system retrieves all applicable model FOLIOs for that club member. The club member reviews the model FOLIO options and selects the Potato Club FOLIO (see screen 410 in FIG. 41). In this case, the club member is able to choose to review or automate trades (auto sync). The system would return the asset allocation screen where the user can enter the amount they want to invest, the name of the FOLIO and their dividend option. The system confirms his instructions and proceeds to the Preview and Place Order screen. The club member confirms the order for the FOLIO and the system places the order. The club member logs off the system.

The investment club member has now purchased the Model FOLIO.

Retail Client

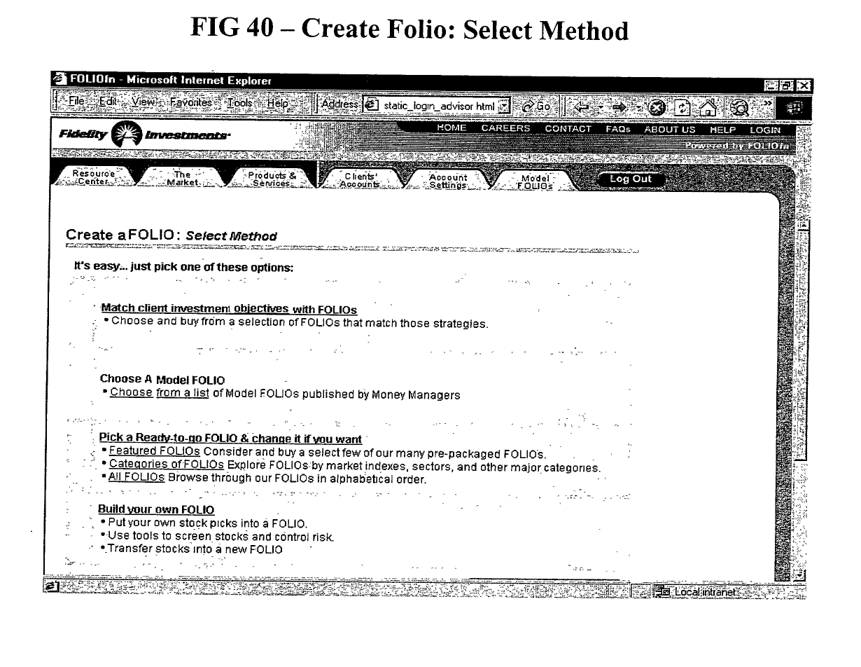

The subscription process for retail clients is virtually the same as the subscription process for institutional clients. The retail user initiates the subscription process by selecting the “Choose a Managed FOLIO” link from list of FOLIO creation methods in the screen 400 shown in FIG. 40.

The user is then presented with the model FOLIOs he or she is able to subscribe to. For example, Investment Clubs members are able to subscribe to the Model FOLIO created by the Club Manager, as shown in the screen 410 in FIG. 41.

Once a model FOLIO has been selected, the user follows the same flow as the institutional client. In essence, the user has to choose their synchronization method (auto or on-demand), their asset allocation and name of the FOLIO, the preview order screen, and a confirmation order screen. The retail look and feel is the only difference between the two flows.

Once the transaction has been completed, an order is generated to buy into the model FOLIO. Additionally, a subscription link exists between the retail customer's FOLIO and the model FOLIO. The link: (1) helps tie the model FOLIO and the retail member's model FOLIO; (2) helps identify the accounts, and FOLIOs, that need to be updated when a change is made in the model FOLIO; (3) helps identify the type of synchronization link that should exist between the model FOLIO and the receiving accounts; (4) helps identify any restrictions that may exist in the receiving accounts.

Retail clients continue to have the ability to add stock specific and socially excludable restrictions to the account. They are able to do this using existing “Account Restriction” screens and the flow is the same. Any addition, change, or deletion of restrictions must be stored, or mapped, to the subscription link.

To unsubscribe from a managed FOLIO, the retail user has the same capabilities as the institutional client. They are able to access the subscription page through their “My Profile” screen. A system of checks and balances may be employed for Investment Clubs where the Club Manager is notified of members who unsubscribe from the model FOLIO. This action may affect their billing status.

Retail clients are also able to change their “Synchronization” selection. This functionality allows the user to choose between an automatic link or a reviewed link.

An Automatic Link automatically generates the necessary orders in an attempt to match the model FOLIO's holdings and weights to the user's holdings and weights in their specified FOLIO. The automatic synchronization command can be overwritten by an account restriction placed by the user using the tool specified above.

A Reviewed Link automatically generates an order request in the user's account without processing the order. This process also triggers an alarm e-mail to the user notifying them of the outstanding order and the procedures necessary to accept or reject the order.

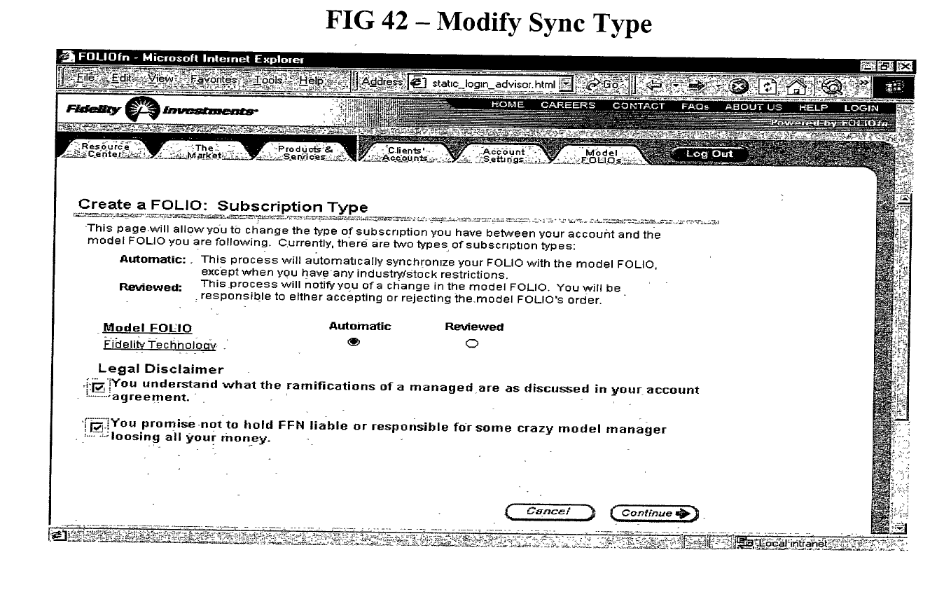

The user is able to modify their synchronization type by accessing a page 420 as shown in FIG. 42. The screen includes the following functionality:

Selection buttons: the user is defaulted to the synchronization type they chose during the subscription of the model FOLIO. However, he/she will be able to modify their selection.

Check boxes—the check boxes allow the user to take a positive action agreeing to the terms of having an automatic process.

Display fields—to display the FOLIO where the change will take place.

Error checks—if the user wants an automatic synchronization, they must select all applicable check boxes. If the user wants a reviewed synchronization, they do not need to select any check boxes.

Buttons—Navigational buttons on this page cancel the transaction or continue with the process.

Once the user has selected their change, they are presented with a “Change Confirmation” page. A “Pending Order” page may be added. The user will be presented with this page in two occasions:

(1)—Reviewed subscription type. Every time a change is made to the model FOLIO, the user sees this page alerting them of the pending order.

(2)—Restriction kick-out event: Every time a change is made to the model FOLIO, and the change triggers a user's Industry/Stock restrictions, they see this page.

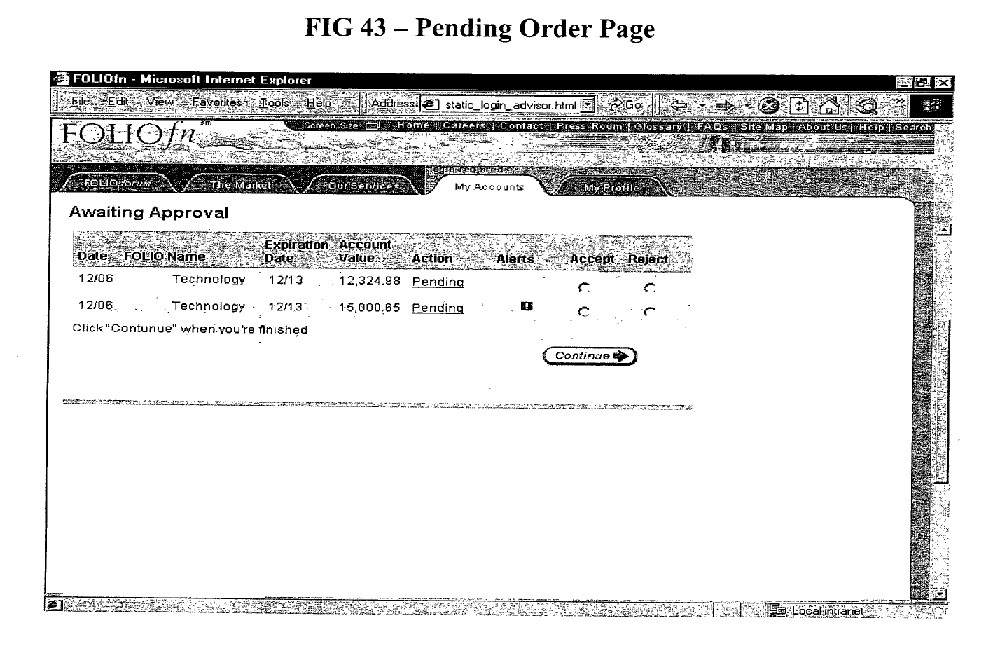

The retail user sees this page the next time they access their membership and may not continue until they have made a decision. The “Pending Order” page 430 is shown in FIG. 43.

This page includes the following functionality:

Display fields—to provide the user all the relevant information such as:

Order date

Name of the FOLIO affected

Expiration Date of the order (initially 7 calendar days)

Transaction Value

Action

Alerts

Links—each pending item on this page is linked to a detailed page. This detailed page allows the retail user to preview the order being proposed. The detailed page may be in the form of a pop-up screen. An “Alert” icon may be included that will be linked to the detailed page specifying the reason for the order being kicked out.

Selection buttons—each pending item has an “Accept” and “Reject” button. These buttons either allow the order to be executed in the next possible window, or erase the transaction altogether. Only one button per item may be selected.

Error checks—to ensure that the user has selected one of the selection buttons before they are able to continue.

Creating and Processing Orders

The final step in the FOLIO Sync process involves reviewing and processing the re-sync orders. The level of effort necessary to review the orders differs from firm to firm and depends on the level of manual control the firm wishes to have over the clients' accounts. Investment advisors with highly customized client accounts require additional manual changes to folios. While investment advisors maintaining accounts that always mimic the model folio rely on automation and require less interaction with the orders themselves.

### EXAMPLE 9

### The System Generates Pending Trades to Re-Sync Subscribed FOLIOS

In this example, the system generates a list of pending trades based on the changes made by a Model Manager to a model manager. When preparing each trade for subscribed folios, the system verifies that the trade does not violate any existing stock or social exclusions.

In general, a model manager changes his model FOLIO and the system receives a command to sync any associated subscribed FOLIO. The system prepares a list of folios affected and generates an order for each. For any subscribed FOLIOs that have exclusions set, the system reviews the trade details against the restrictions. The user is the FOLIO System.

We shall assume the model manager has modified a model FOLIO using FOLIO Advisor. At least one advisor's customers were previously subscribed to the model FOLIO.

The process continues as follows. The system receives a command to sync all subscribed folios with a Model FOLIO. The system identifies the list of folios that are currently subscribed to the IA's folio. The system evaluates the changes necessary to each folio to resync with the target folio. The system places a rebalance order on each subscribed folio. The result is a list of associated security orders that reflect the changes necessary for resyncing with the model folio. For all folios subscribed in a fully automated manner, the system loads the orders in to the next window. For any orders requiring manual review, the system creates the folio order along with the appropriate security orders and place the orders in a pending review state.

Now the list of pending FOLIO orders have been created and are awaiting the investment advisor review.

### EXAMPLE 10a

### IA Reviews Pending Trades—IA Releases Orders Not Requiring Follow-Up

In this example, the investment advisor uses the FOLIO Advisor product to review the pending trades created as a result of a model manager making modifications to a model FOLIO. The investment advisor reviews each automatically generated order prior to releasing the order in to the next window. Each “accepted” trade is placed in the next window for execution.

The investment advisor logs into the Advisor site. She reviews the trades generated as a result of the model FOLIO changes. With each trade she determines whether the trade should be released as is, canceled, modified, or held in a pending state for future follow-up. The user is the Investment Advisor.

We shall assume the system has created a list of pending orders based on modifications made to the Model FOLIO.

The process continues as follows. The investment advisor logs in at www.folioadvisor.com. The IA navigates to the Review Pending Orders screen. The system displays a screen containing all the orders pending review for the logged in user. The IA reviews the details of each trade. For each order the IA determines the appropriate action to take on the order. The available actions include:

(1) Releasing the order for processing in the next window

(2) Canceling the order entirely

(3) Modifying the order to more closely match the client's needs

(4) Leaving the order in a pending review state for future action.

The IA confirms which orders are ready for processing in the next window by selecting the Confirm radio button. The IA releases all confirmed orders by selecting the Process Orders push-button. For those orders that the IA confirmed as “ready”, the system creates a folio order in the ftc_folioorder and associated security orders in the ftc_securityorder table, assigning the order(s) to the next window.

The flagged orders are now placed in the next window. The processed orders are removed from the IA's Review Pending Orders screen.

### EXAMPLE 10B

### IA Reviews Pending Trades—IA Cancels Pending Trade

In this example, the investment advisor uses the FOLIO Advisor product to review the pending trades created as a result of a model manager making modifications to a model FOLIO. The investment advisor reviews each automatically generated order prior to releasing the order in to the next window. The IA cancels any order not in their clients' best interest.

The investment advisor logs into the Advisor site. She reviews the trades generated as a result of the model FOLIO changes. With each trade she determines whether the trade should be released as is, canceled, modified, or held in a pending state for future follow-up. The user is the Investment Advisor

We shall assume the system has created a list of pending orders based on modifications made to the Model FOLIO.

The investment advisor logs in at www.folioadvisor.com. The IA navigates to the Review Pending Orders screen. The system displays a screen containing all the orders pending review for the logged in user. The IA reviews the details of each trade. For each order the IA determines the appropriate action to take on the order. The available actions include:

(1) Releasing the order for processing in the next window

(2) Canceling the order entirely

(3) Modifying the order to more closely match the client's needs

(4) Leaving the order in a pending review state for future action.

The IA chooses to review the details of a pending trade by selecting the Details hyperlink under the Confirm Trades column. The system displays a screen showing the details of the trade. The IA selects the Cancel order push-button on the order details screen. The system marks the trade as canceled and returns the user to the Review Pending Orders screen.

Now, the order has been appropriately marked as canceled and will not be processed in the window. The system has removed the canceled order from the IA's Review Pending Orders screen.

### EXAMPLE 10C

### IA Reviews Pending Trades—IA Modifies a Pending Order

In this example, an investment advisor uses the FOLIO Advisor product to review the pending trades created as a result of a model manager making modifications to a model FOLIO. The investment advisor reviews each automatically generated order prior to releasing the order in to the next window. Prior to placing an order, the investment advisor makes modifications to the order.

The investment advisor logs into the Advisor site. She reviews the trades generated as a result of the model FOLIO changes. With each trade she determines whether the trade should be released as is, canceled, modified, or remain in a pending state for future follow-up. The user is the Investment Advisor

We shall assume the system has created a list of pending orders based on modifications made to the Model FOLIO.

The investment advisor logs in at www.folioadvisor.com. The IA navigates to the Review Pending Orders screen. The system displays a screen containing all the orders pending review for the logged in user. The IA reviews the details of each trade. For each order the IA determines the appropriate action to take on the order. The available actions include:

(1) Releasing the order for processing in the next window

(2) Canceling the order entirely

(3) Modifying the order to more closely match the client's needs

(4) Leaving the order in a pending review state for future action.

The IA chooses to review the details of a pending trade by selecting the Details hyperlink under the Confirm Trades column. The system displays a screen showing the details of the trade. The IA selects the Modify order push-button on the order details screen. The system opens the Folio Modifier screen. The investment advisor uses the folio modifier to adjust the proposed order. When finished, the investment advisor selects the Place trade push-button. The system creates a folio order in the ftc_folioorder and associated security orders in the ftc_securityorder table, assigning the order to the next window.

The flagged orders are now placed in the next window. The processed orders are removed from the IA's Review Pending Orders screen.

### EXAMPLE 11

### IA Reviews Executed Trades in Clients Accounts

An investment advisor uses the FOLIO Advisor product to review executed trades placed recently in her client's accounts. The advisor verifies that each order was properly executed.

The investment advisor logs into the Advisor site. She reviews the trades recently executed as a result of the model FOLIO changes. With each trade she verifies that the trade was properly executed. For any orders partially filled, the investment advisor navigates to the customers account to determine if additional follow up action is required. The user is the Investment Advisor. We shall assume the advisor has an order(s) processed in a recent window.

The investment advisor logs in at www.folioadvisor.com. The IA logs in to the system and navigates to the Orders Status screen. The IA reviews the details of each trade to verify that the order was executed entirely. Any order that was executed partially is flagged accordingly. The IA selects the order hyperlink to receive additional details on the execution of a trade. The system displays execution details on each filled security orders and provides reasons for incomplete orders (e.g. stock not trading, market halt, etc.). If the advisor opens the customer's account to make further enhancements to the customer's folio. The advisor makes modifications to the folio using the existing IA sites features.

Any follow-up orders placed by the investment advisor are created and assigned to the next window.

Review Pending Orders Screen

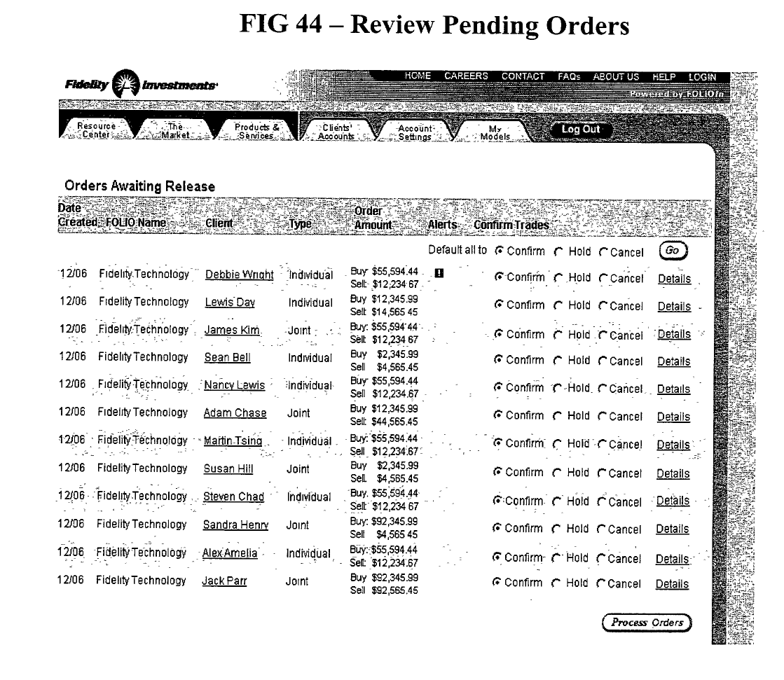

Turning to FIG. 44, the screen 440 shown therein contains summary details on each of the orders that are awaiting the investment advisor's review. The IA uses this screen as the starting point for review all pending trades across all of his/her customer's accounts. For orders that require no additional action, the IA can release the orders in to the next window from the Review Pending Orders screen. Otherwise, the advisor can drill down in to individual customer order to further review, cancel, or modify the pending orders.

Folio Order Details

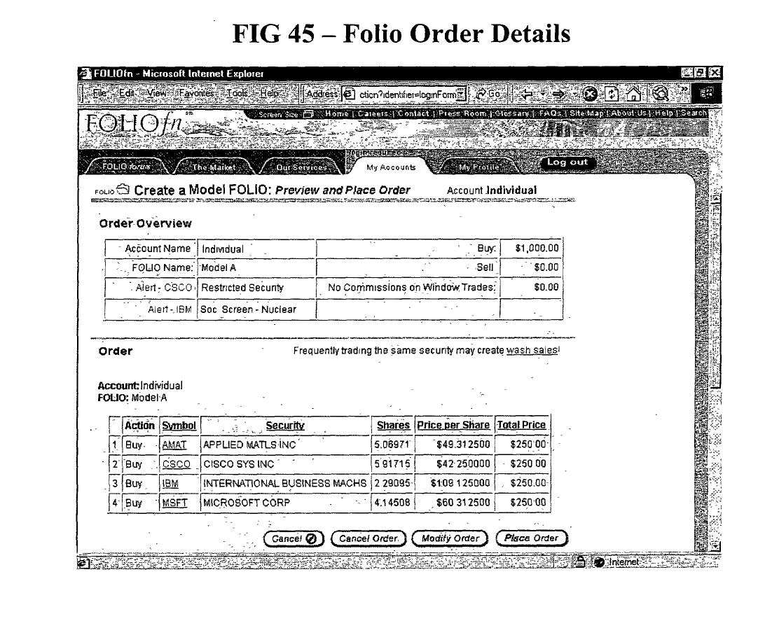

Turning to FIG. 45, the screen 450 shown therein provides details on the actual buys/sells that take place in the customer's accounts. From this screen the advisor may choose to place, cancel, or modify the order. The screen is very similar to the Confirm Folio Order Details screen.

The investment advisor also uses this screen to review alerts on an individual trade. The alerts may range from a social exclusion to a short-term gain. The system will support social and individual stock screens. As the system grows more robust, the system will support additional review types (e.g. detailed tax implications, industry restrictions, asset mix restrictions, stock %, industry % restrictions, min % cash, etc.).

Folio Modifier

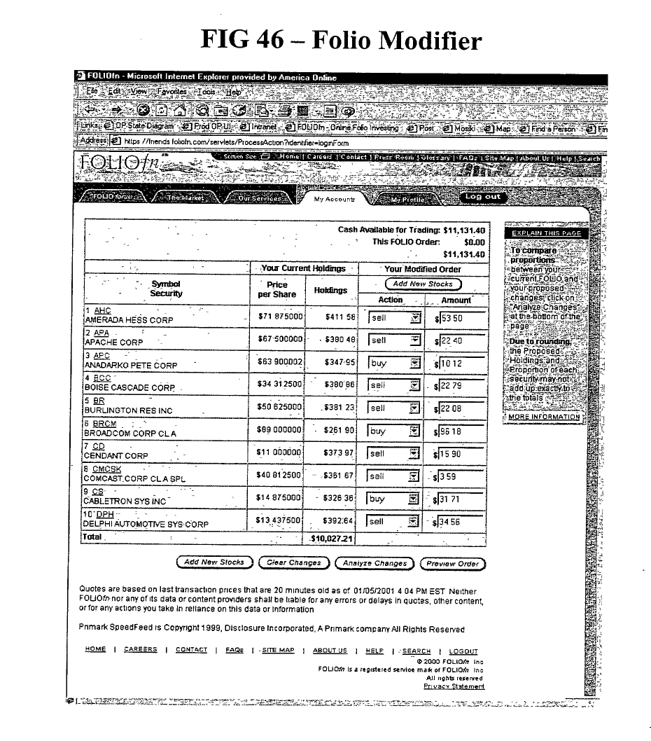

Turning to FIG. 46, the screen 460 shown therein provides the investment advisor with the ability to modify the buys and sells associated with the pending folio order. After finished modifying the order, the advisor may place the order in the next window or save the order back to the pending review list for future follow-up.

Order Status

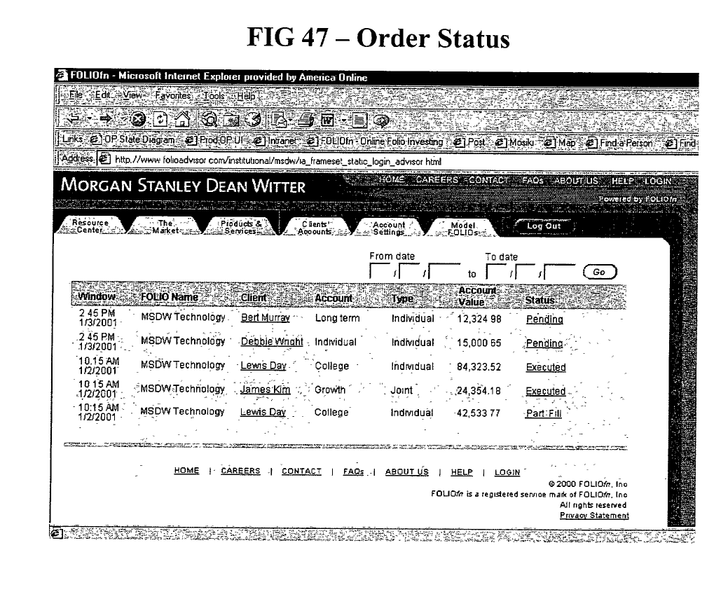

Turning to FIG. 47, the screen 470 shown therein allows the investment advisor to review the details associated with his/her customer's processed trades. For each folio order, the IA can click to see actual fill details and determine if and why a folio order was not entirely executed. If additional follow-up orders are necessary, the IA may create a corrective order by opening the customer's account.

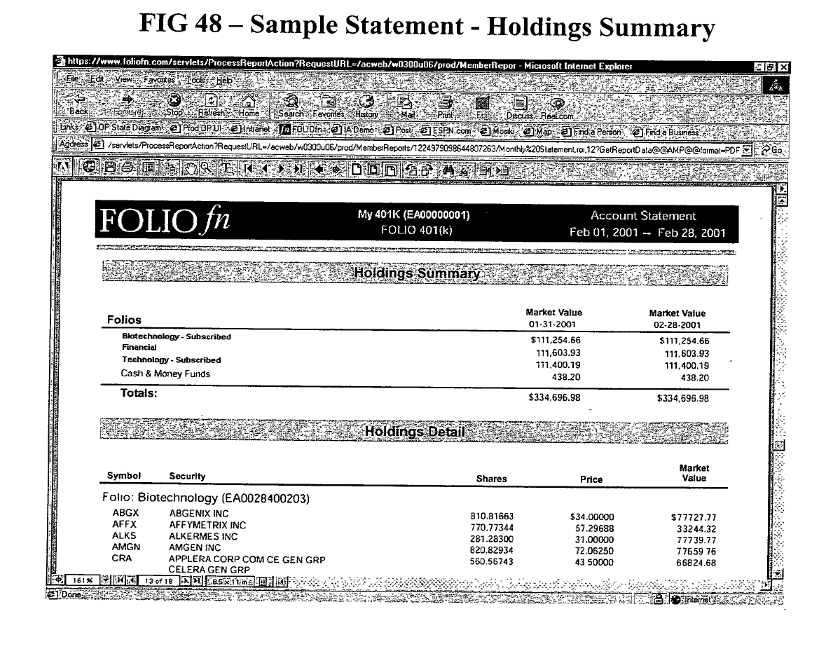

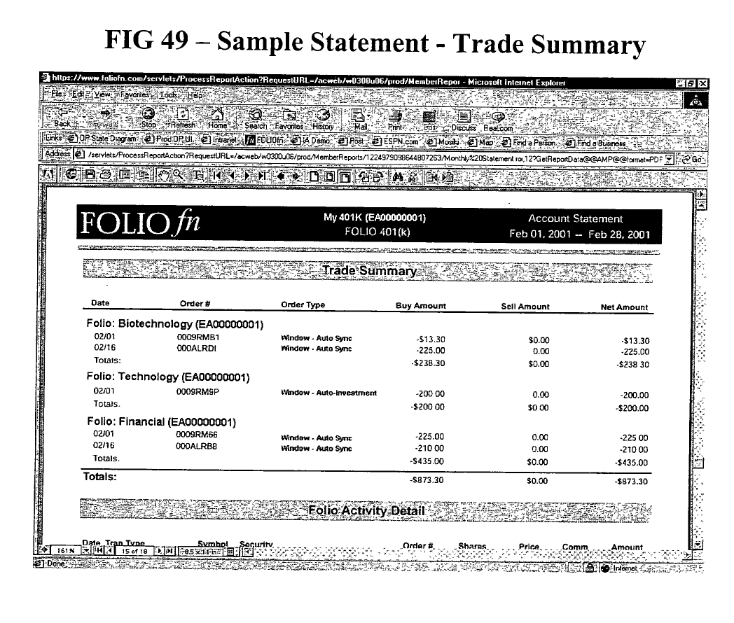

FIG. 48 shows a sample statement 480—Holdings Summary, whereas FIG. 49 sample statement 490—trade summary.

Confirms

In order to identify that an order was created as a result of a synch request, the order type field on the existing customer confirm requires modification. The order type field in the Order Summary section of the confirm will be modified to display how the order was created. The system will use the contents of the ordersubtype field to determine how the order was placed. The table shown below includes the text displayed for each ordersubtype.

| Ordersubtype | Text |
|---|---|
| A | Auto-Investment |
| D | Dividend Reinvest |
| T | Easy Trade |
| R, V, M, X | Advanced Trade |
| C | Initial Purchase |
| S | Sync |

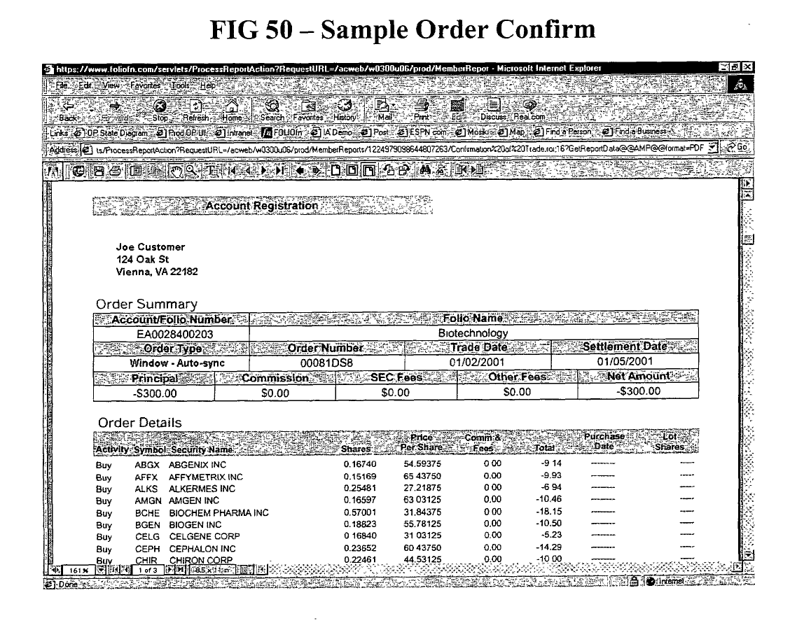

FIG. 50 shows a Sample Order Confirm screen 500.

Sync Request Manager

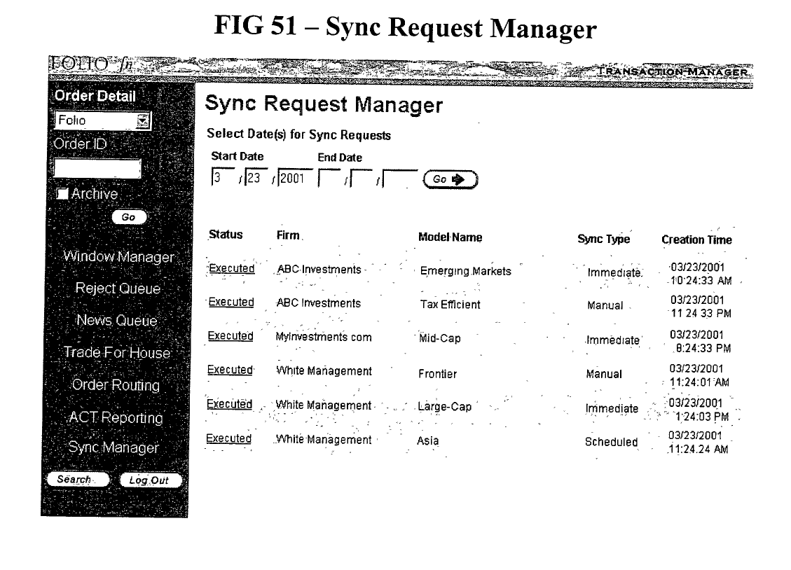

The sync request manager 510 shown in FIG. 51 provides brokerage ops with a list of sync requests created over the user-entered period of time. Some embodiments of the Sync Request Manager screen will provide view only access, while others will allow brokerage ops to specify the window in which the sync request should be processed.

Sync Request Detail

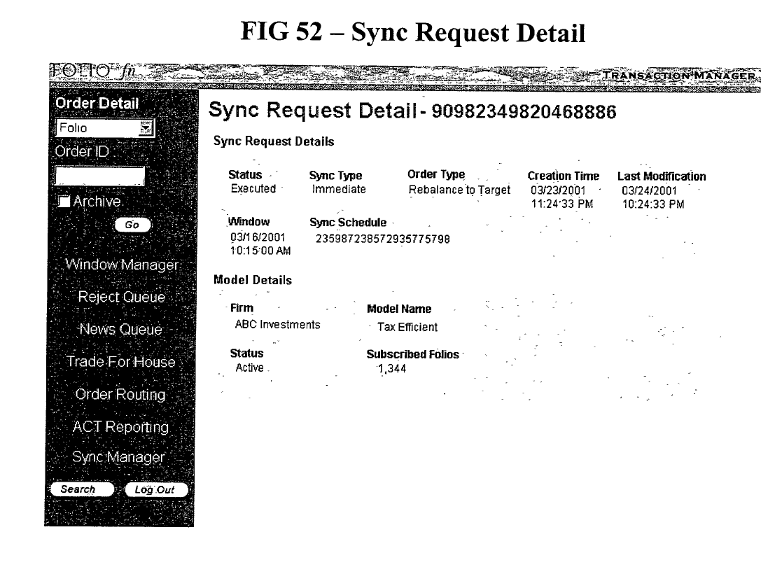

The sync request details screen 520 shown in FIG. 52 provides brokerage ops with detailed information about a specific sync request. Some embodiments of the Sync Request Manager screen will provide view only access, while others will allow brokerage ops to take action on the sync request.

Alerts

The system sends an alert to the Investment Advisor whenever the following occurs:

Model Manager Changes Model

The system sends an alert to any investment advisor with clients in the model whenever the model changes. The system only sends one instance of the alert per investment advisor.

Auto-Sync Process Fails when Creating an Order

If the system encounters an error when trying to create a sync order in a customer's account, the system sends an alert e-mail to the Investment Advisor noting the model name, customer name, customer account number, and reason for failure. If failures occur in multiple clients' accounts, the system delivers a single alert e-mail to the investment advisor containing information on all the trade failures.

Identifying Linked Folios

The system ties each folio back to the associated pre-packaged folio in instances where the folio was purchased as a ready-to-go folio. Each folio originally created by purchasing a ready-to-go folio is tied back to the pre-packaged folio using the prepackagedfoliooid field on the ftc_folio table. A similar concept is used for tying managed folios with their associated model folio. Each time a model manager initiates a change in the model folio and wishes to “push” the changes down to each subscribed folio, the system uses this link to identify affected folios. The subscribed folios/model folios are linked in such a manner that entire table scans are not required each time a model manager chooses to update the subscribed folios.

Similarly, the system may identify folio orders linked to a particular investment advisor. The system uses this link to display all “Pending Review” orders as well as to display all executed order details once the trades have been processed. Again the method used for linking the IA with the appropriate trades takes in to account performance.

Resync with Model Folio

The system requires the flexibility to either set the target weights of the subscribed folio to the existing weights of the Model Folio or the target weights of the Model Folio.

Whenever a model manager initiates a request to re-sync subscribed folios with the model folio, the system creates a list of subscribed folios. The system applies a rebalance order against each of the affected folios to generate a list of associated buys and sells necessary to bring each subscribed folio in-line with the new model folio. Prior to creating a folio order and associated security orders, the system verifies that each security order passes the customer defined restrictions. The system will support the following customer defined restrictions:

Stock Exclusions

Relies on social exclusions logic. If the model folio contains any security order that is contained in the social exclusion group for that customer, the system flags the order for the IA to review. The IA may choose to remove the stock from the folio order or execute the trade as is.

Social Exclusions

Relies on social exclusions logic. If the model folio contains any security order that is contained in the social exclusion group for that customer, the system flags the order for the IA to review. The IA may choose to remove the stock from the folio order or execute the trade as is.

Summary

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific communication techniques and protocols between various embodiments, any communication technique will suffice to transfer information regarding the manager's folio. Furthermore, these examples should not be interpreted to limit the modifications and variations of the invention covered by the claims but are merely illustrative of possible variations.

What is claimed is:

1. A method for creating an electronic marketplace of investment advice for consumers of investment advice, each of which are engaged in electronic portfolio trading of market tradable assets/liabilities, comprising:
enabling a plurality of advisors to each electronically create a model portfolio of market tradable assets/liabilities;
electronically disseminating the plurality of model portfolios created by the plurality of advisors as a plurality of preset portfolios that can be purchased singly or in combination with each other by one or more consumers, a result of which can then be electronically traded as an entire portfolio of market tradable assets/liabilities by the one or more consumers; and
displaying a fee associated with each of the plurality of model portfolios that must be paid to an advisor that created the model portfolio upon selecting to purchase said each of the plurality of model portfolios singly or in combination with one or more other model portfolios.

2. The method according to claim 1, further comprising deducting any fee associated with a particular model portfolio purchased by a consumer from funds allocated to the purchased portfolio and forwarding the fee to a respective advisor.

3. The method according to claim 1, further comprising selecting one or more model portfolios by an investor engaged in electronic portfolio trading and allocating funds in amounts specified by the investor to each of the one or more model portfolios.

4. The method according to claim 1, further comprising executing trades in individual markets for each market tradable asset/liability in each of the one or more selected model portfolios based upon a respective weighting for said each market tradable asset/liability and a respective specified amount for each selected model portfolio.

5. The method according to claim 3, further comprising:
customizing said one or more model portfolios in accordance with an investor specification to create an investor-modified model portfolio.

6. The method according to claim 5, further comprising storing the modifications specified by the investor.

7. The method according to claim 6, further comprising notifying an investor of changes made by the advisor in a model portfolio in which the investor has traded.

8. The method according to claim 7, further comprising rebalancing the investor-modified model portfolio in accordance with said changes.

9. The method according to claim 8, further comprising modifying the rebalanced investor-modified model portfolio in accordance with the stored modifications.

10. The method according to claim 8, further comprising moving a plurality of excess securities into another investor-created portfolio as part of the rebalancing if the plurality of excess securities are to-be sold as recommended by an advisor.

11. The method according to claim 8, further comprising rebalancing by buying and selling market tradable assets/liabilities.

12. The method according to claim 8, further comprising rebalancing by only buying market tradable assets/liabilities.

13. The method according to claim 1, further comprising debiting an individual investor's account in accordance with a fee associated with a particular model folio when said individual investor trades a portfolio including the particular model folio.

14. The method according to claim 13, further comprising transferring the fee to a particular manager associated with said particular model folio.

15. The method according to claim 1, further comprising debiting an individual investor's account in accordance with a fee associated with a particular model portfolio when said individual investor sells a portfolio including the particular model portfolio.

16. The method according to claim 15, further comprising transferring the fee to a particular manager associated with said particular model folio.

17. The method according to claim 15, wherein the fee comprises a performance based fee.

18. A computer-readable medium storing instructions that, when executed by one or more processors, cause the one or more processors to perform activities for creating an electronic marketplace of investment advice for consumers of investment advice, each of which are engaged in electronic portfolio trading of market tradable assets/liabilities, said activities comprising:
enabling a plurality of advisors to each electronically create a model portfolio of market tradable assets/liabilities;
electronically disseminating the plurality of model portfolios created by the plurality of advisors as a plurality of preset folios that can be purchased singly or in combination with each other by one or more consumers, a result of which can then be electronically traded as an entire portfolio of market tradable assets/liabilities by the one or more consumers; and
displaying a fee associated with each of the plurality of model portfolios that must be paid to an advisor that created the model portfolio upon selecting to purchase said each of the plurality of model portfolios singly or in combination with one or more other model portfolios.

19. The computer readable media according to claim 18, wherein the activities further comprise deducting any fee associated with a portfolio purchased by a consumer from funds allocated to the purchased portfolio and forwarding the fee to a respective advisor.

20. An apparatus for creating an electronic marketplace of investment advice for consumers of investment advice, each of which are engaged in electronic portfolio trading of market tradable assets/liabilities, said apparatus comprising:
means for enabling a plurality of advisors to each electronically create a model portfolio of market tradable assets/liabilities;
means for electronically disseminating the plurality of model portfolios created by the plurality of advisors as a plurality of preset folios that can be purchased singly or in combination with each other by one or more consumers, a result of which can then be electronically traded as an entire portfolio of market tradable assets/liabilities by the one or more consumers; and
means for displaying a fee associated with each of the plurality of model portfolios that must be paid to an advisor that created the model portfolio upon selecting to purchase said each of the plurality of model portfolios singly or in combination with one or more other model portfolios.

21. The apparatus according to claim 20, further comprising means for deducting any fee associated with a portfolio purchased by a consumer from funds allocated to the purchased portfolio and forwarding the fee to a respective advisor.

22. A method for creating a virtual marketplace of investment advice comprising:
providing a commoditized investment advice vehicle via which an investment advisor can provide investment advice; and
electronically disseminating a plurality of the commoditized investment advice vehicles, each of which includes investment advice from a particular investment advisor, to a plurality of consumers of investment advice.

23. The method according to claim 22, further comprising displaying the plurality of commoditized investment advice vehicles along with an associated purchase price set by the particular investment advisor for each of the plurality of commoditized investment advice vehicles.

24. The method according to claim 22, further comprising enabling each of the plurality of consumers of investment advice to purchase one or more of the commoditized investment advice vehicles.

25. The method according to claim 24, further comprising collecting the purchase price from each purchasing consumer upon purchase of a commoditized investment advice vehicle.

26. The method according to claim 25, further comprising forwarding the fee to an investment advisor that created the purchased commoditized investment advice vehicle.

27. The method according to claim 22, wherein the commoditized investment advice vehicle comprises a model portfolio of investments.

28. The method according to claim 27, wherein the consumers include investors engaged in portfolio trading of entire portfolios of investments.
